(19) United States
(12) Patent Application Publication
(10) Pub. No.: US 2011/0234605 A1
(43) Pub. Date: Sep. 29, 2011

(54) DISPLAY HAVING SPLIT SUB-PIXELS FOR MULTIPLE IMAGE DISPLAY FUNCTIONS

(76) Inventors: Nathan James Smith, Oxford (GB); Benjamin James Broughton, Abingdon (GB); Patrick Zebedee, Oxford (GB); Jonathan Mather, Oxford (GB)

(21) Appl. No.: 12/732,283

(22) Filed: Mar. 26, 2010

(51) Int. Cl. G06T 1/00; G09G 3/34; G02B 27/22

(52) U.S. Cl. 345/522; 345/84; 359/462; 348/E13.075

(57) ABSTRACT

A display which includes a plurality of sub-pixels each split into a plurality of sub-regions. Each sub-pixel includes a single gate line and a single signal line, and each sub-region within a given sub-pixel includes a corresponding storage capacitor line. An optical element cooperatively combines with the plurality of sub-pixels to create distinct angularly dependent brightness functions in association with corresponding sub-regions within the sub-pixels. Control electronics are configured to provide image data levels in the form of signal data voltages to each sub-region included within each sub-pixel via the gate line and signal line included within the sub-pixel; and to independently modify the signal data voltages provided to each sub-region within the sub-pixels via the corresponding storage capacitor lines whereby the display operates in accordance with at least two different image functions.

### TECHNICAL FIELD

The invention relates to a display and sub-pixels included therein. Such a display may be used as a directional display in, for example, a mobile phone, portable media players, games devices, a laptop personal computer, a television, a desktop monitor, etc. Such a display device is capable of at least two different image display modes among, for example, a conventional display, a privacy display, an autostereoscopic 3D display.

### BACKGROUND ART

Multiple users can view the same image on a conventional display device simultaneously. The properties of a conventional display device are such that viewers can see the same image from different angles with respect to the display (hereafter “Public Mode”). This is effective in applications where many users require the same information from the display—such as, for example, displays of departure information at airports and railway stations. However, there are many applications where it would be desirable for an individual user or multiple users to be able to see angular dependent information from the same display. Example 1—“Privacy”: a single display user who wishes to view confidential material in a public place and would therefore find it desirable to display the confidential image on-axis only (i.e. for the user's eyes only) and to display a non-confidential image off-axis that could be viewed by 3rd parties. Example 2—“3D Function”: in order to view a 3D image (an image with perceived depth) from a display, a single user requires different images (a “stereoscopic pair”) to be directed to each eye.

GB2405542 (J. Mather, et al.; March 2005) describes the use of a parallax optic and a display for creating a directional display. Embodiments within GB2405542 concentrate on realising a Dual View display whereby two independent images are viewable in two different principal directions. The application for in-car use is emphasised and accordingly one image is viewable to the left of the display's normal axis while the second image is viewable to the right of the display's normal axis. GB2405542 also mentions that a switchable privacy display may also be realised that enables a public wide view mode and a private narrow view mode. However, GB2405542 does not teach explicitly how to realise a privacy display nor does it describe how to electronically switch between the public wide view mode and a private narrow view mode of said privacy display.

On Sep. 27, 2006, Sharp Kabushiki Kaisha announced a “Triple View Directional Viewing LCD” (hereafter “Triple View Display”) which offers simultaneous display of three independent images by combining an existing liquid crystal device (LCD) with a parallax optic. The display comprises a display device and a parallax optic formed on a substrate and displays the three views such that they are viewable in viewing regions. This LCD is capable of the following image functions: a public wide view mode and a Triple View mode. In the Triple View mode, three independent images are displayed that are viewable from different directions, such that one image is viewable substantially on-axis by a viewer while another image is viewable substantially off-axis to the left of the display by a viewer while another image is viewable substantially off-axis to the right of the display by the viewer. The Triple View mode also serves as a privacy mode since an on-axis user can view content that cannot be viewed off-axis. By directing the same image to the left, centre and right views, a normal public mode is realised on the Triple View Display. The main disadvantage of the public mode is that images have only 33% resolution and approximately 33% brightness compared to an identical image panel without the parallax optic attached. This relatively poor public mode performance limits the application of the display mode to relatively niche markets.

GB2426352 (E. Walton, et al.; November 2006) describes a display that can yield a public wide view mode, a private narrow view mode and an autostereoscopic 3D mode. U.S. Pat. No. 7359105 (A. Jacobs, et al.; April 2008) describes a display that can yield a public wide view mode, a private narrow view mode, a Dual View mode and an autostereoscopic 3D mode. The main disadvantage of both GB2426352 and U.S. Pat. No. 7,359,105 is that, in order to realise a display with extra image functions, an additional liquid crystal switch cell is required. The extra liquid crystal switch cell increases the relative thickness and weight of the whole display module by approximately 40%. The extra weight and thickness are very undesirable, especially for mobile display products such as mobile phones, laptop personal computers etc. Methods of changing the viewing angle properties of a display panel using additional liquid crystal cells are also described in GB2413394 (R. Winlow, et al.; October 2005), GB2427033 (D. Kean, et al.; December 2006), GB2439961 (N. Smith, et al.; January 2008), JP3607272 (T. Takato, et al.; January 2005), JP3607286 (T. Takato, et al.; January 2005), US5825436 (K. Knight; October 1998) and WO04070451 (G. Woodgate, et al.; August 2004).

Related prior art in the use of lenses and parallax optics for creating non-switchable privacy displays include: JP2002299039 (N. Furumiya; October 2002), JP2006236655 (K. Furukawa, et al., September 2006), U.S. Pat. No. 6,809,470 (R. Morley, et al.; July 2002), U.S. Pat. No. 7,091,652 (R. Morley, et al.; August 2006), U.S. Pat. No. 6,935,914 (A. Ito, et al.; August 2005), WO0133598 (J. Sturm, et al.; November 2001), and WO03007663 (S. Moeller, et al.; January 2003). A display that does not have the capability of switching between a public wide view mode and a private narrow view mode has an inherent disadvantage over displays that are switchable between the two modes.

A stereoscopic display gives the illusion of depth in the image by giving each eye a different perspective of a scene, as would happen in reality. The brain then fuses these perspectives together to form a 3D representation of the image in the brain. For example, this may be done by displaying one perspective with one polarisation, and the other perspective in a different polarisation. A viewer can then see stereoscopic depth by wearing glasses where each eye piece only allows the appropriate polarisation to pass.

An auto-stereoscopic display is a display that gives stereoscopic depth without the user needing to wear glasses. It does this by projecting a different image to each eye. These displays can be achieved by using parallax optic technology such as a parallax barrier or lenticular lenses.

These types of displays are well known in the literature. For instance, the design and operation of a parallax barrier for 3D is well described in the paper “3-D Liquid Crystal Displays and Their Applications” by L. Hill and A. Jacobs (Proceedings of the IEEE, Volume 94, Issue 3, March 2006, pp 575-590) and in U.S. Pat. No. 7,505,203B2 (H. Nam, et al.; March 2009).

In summary, FIG. 1 shows the basics of the parallax barrier operation and design. It shows a cross sectional diagram of an auto-stereoscopic parallax barrier design. The images for the left and right eye are interlaced on alternate columns of pixels, as for previous designs. The slits in the parallax barrier allow the viewer to see only left image pixels from the position of their left eye, right image pixels from the right eye. The viewer may look on-axis at the display (i.e. observe from the direction perpendicular to the plane of the display) to see a stereoscopic view, but note that they may also see a stereoscopic view off axis (observing from an oblique angle to the plane of the display) as shown in FIG. 1 by the dashed lines. The on axis view is called the primary viewing window, and the off axis view is called the secondary viewing window.

The same 3D effect can be achieved by using lenticular lenses. Each lens is substantially equivalent to a slit on the parallax barrier. FIG. 2 and FIG. 11 shows a conventional 3D system using lenticular lenses. The lenses image the pixels to the viewer. As shown in the diagram, light from the left pixels is directed into the observers left eye, and vice versa. To achieve this, the focal length is typically set such that it is about equal to the lens-pixel separation distance (so that the focal length of the lens is approximately at the plane of the pixels). This design works very well and has been used for many years to create good stereoscopic displays.

A key disadvantage to autostereoscopic displays which use a parallax barrier or lenticular array is that the light emitted from each pixel of the underlying display is always directed to one eye or the other—there is no way for both eyes to observe all the display pixels simultaneously. This means that if the display is to be used in a 2D image mode—i.e. the same image displayed to both eyes as with a standard 2D display, the observed image has half the resolution. In order to circumvent this drawback, 2D-3D switchable displays have been produced such as those described in U.S. Pat. No. 5,969,850 (J. Harrold, et al.; October 1999), US20060098296A1 (G. Woodgate, et al.; May 2006) and WO2007099488A1 (W. Ijzerman, et al.; September 2007). These displays though, while being electronically switchable between a 3D mode, and a 2D mode and therefore providing the full brightness and resolution of the base panel, require additional active optical elements to be added to the display to provide the 2D-3D switching functionality. This adds cost and thickness, which can be critical in a mobile display application, to the overall display module.

Methods of using capacitive coupling to the pixel electrode in active matrix displays, in order to apply an offset to the data signal voltage, both to minimise the range of signal voltages which is required to produce a full range of pixel luminances from fully off to fully transmissive, and to provide a power efficient means of alternating the polarity of the voltage across the liquid crystal layer in each pixel region every frame are also well known. Capacitively coupled driving, in which the signal data voltage is supplied to the pixel electrode from a source data line, via a TFT element, during the period the gate of the TFT is on, in order to charge the pixel electrode and storage capacitor to the voltage of the data signal, and then after the gate of the TFT is switched off, an offset is imposed the voltage on the pixel electrode via capacitive coupling to the pixel electrode of a second voltage applied to the side of the storage capacitor insulated from the pixel electrode, is described in EP00336570A1 (S. Nagata, et al.; October 1989) and U.S. Pat. No. 5,296,847 (E. Takeda, et al.; March 1994) and in Tsunashima et al, SID Digest '07, pp 1014 -1017. For example, a method is described for writing the signal voltage to be directed to a pixel within a minimised range from 0V, then using a voltage offset applied to storage capacitor line for the whole row of pixels, to shift the signal voltage into the correct range for it to switch the liquid crystal layer to the desired configuration.

LCD displays have been manufactured which utilise a “split sub-pixel” arrangement, whereby each individually addressable display element (e.g. one of three colour sub-pixels in a composite RGB white pixel in a display) is divided into two or more sub-regions which are designed to produce different brightnesses from each other, while producing an overall brightness when observed together which corresponds to the intended brightness for that sub-pixel according to the signal it was addressed with. The purpose of these split sub-pixel display types is to reduce the nonlinearity of the off-axis luminance produced by the pixel measured as a function of the on-axis luminance, over the range of on-axis luminances. Many LCD displays have an inherently non-linear off-axis to on-axis luminance response, which results in degradation of the displayed images quality when viewed off-axis due to factors such as colour shift. By causing each sub-pixel to consist of multiple regions of differing on-axis luminance, the non-linear off-axis luminance of each sub-pixel sub-region is averaged out, resulting in improved overall off-axis image accuracy.

There are several methods of applying a single data voltage to a split sub-pixel which result in the different sub-regions of that split sub-pixel having voltages which are offset from each other, such as capacitive coupling between the different regions (described in U.S. Pat. No. 7,079,214 (F. Shimoshikiryo; July 2006) and charge sharing (S. S. Kim et al., SID '08 Digest, pp 196-199, “Ultra Definition LCD Using New Driving Scheme and Advanced Super PVA Technology”). It should be noted that it is these methods in which a single data voltage is applied to each sub-pixel and while the resulting voltages on each sub-region of the split sub-pixel are offset from each other, they have a fixed relationship to each other and are all dependent on the same single data voltage, which are referred to by the phrase “split sub-pixel”. The type of improved viewing angle display which has multiple sub-pixel sub-regions which are completely independently addressable and therefore can have any voltage relative to each other, by the addition of at least an extra gate or source line per sub-pixel, such as that described in S. S. Kim et al, SID '07 Digest pp 1003-1006, “Novel TFT-LCD Technology for Motion Blur Reduction Using 120 Hz Driving with McFi”, are essentially a doubled resolution display showing images of half the resolution which they are capable of. Compared to the equivalent 2D display, such displays therefore require either double the number of data drivers, or data drivers able to operate at twice the speed. They also require double the number of gate drivers. The drivers may be implemented in TFTs on the display glass or as separate ICs. Each of these changes increases the size, power consumption and cost of the display over its 2D equivalent.

A method of applying a single data voltage to a split sub-pixel which results in the different sub-regions of that split sub-pixel having voltages which are offset from each other, and which allows the voltage offset between the different sub-regions of the split sub-pixel to be controlled such that, in conjunction with a passive optical element, a display switchable between different viewing modes such as public and private, or 2D and 3D, is realised, is given in the patent application WO2009/104816 (B. Broughton, et al.; August 2009). This method is directed towards OLED displays, and specifies that the display counter electrode, on the substrate opposing the active matrix substrate on which the pixel electronics are disposed, has multiple independently controllable regions to allow a plurality of common voltages to be applied to each pixel.

The use of standard pixels in combination with an optical element, a camera module facing the user, face recognition image processing software and associated control mechanisms have previously been disclosed in U.S. Pat. No. 5,808,792 (G. Woodgate, et al.; September 1998) to realise a head tracked 3D system whereby the user can move laterally with respect to the display and always see a 3D image. A disadvantage of this system is that the perceived resolution of the 2D mode and 3D mode is ¼ of the native resolution of the display panel (the native resolution of the display panel is modified by the optical element).

The use of standard pixels in combination with an optical element in order to achieve a display device capable of multiple image function modes (for example, a public wide view 2D mode, a private narrow view 2D mode, a 3D mode, a private 3D mode) has previously been disclosed in WO2009/104818 (N. Smith, et al.; August 2009). A disadvantage of the systems described within WO2009/104818 is the loss in on-axis resolution for the display system i.e. the perceived resolution of the display with multiple image functions is less than the native resolution of the display panel.

### SUMMARY OF INVENTION

In general, any multi-view display that is made up of standard sub-pixels (sub-pixels which are not split) and a passive parallax optic for creating a set of distinct viewing windows for said sub-pixels has a lower perceived 2D resolution than a multi-view display that is made up of split sub-pixels and a similar type of passive parallax optic.

The use of standard sub-pixels (sub-pixels which are not split) in conjunction with a passive parallax optic may yield a display capable of showing 2D images with a perceived resolution of 50%, and 3D images with a perceived resolution of 50%. The use of split sub-pixels in conjunction with a similar type of passive parallax optic may yield a display capable of showing 2D images with a perceived resolution of 100%, and 3D images with a perceived resolution of 50%. The use of time multiplexing techniques with said split sub-pixel display can improve the perceived resolution of the 3D mode to 100%. No costly and bulky additional optically active (i.e. mechanically, electrically or otherwise switchable) elements are therefore required to be added to the base LCD panel as with previous 2D-3D switchable displays that have a perceived resolution of 100% in the 2D mode and a perceived resolution of 100% in the 3D mode.

A display with standard sub-pixels capable of showing 2D images and 3D images using a passive parallax optic will require said parallax optic to have a pitch of substantially 2X microns. A similar display with split sub-pixels capable of showing 2D images and 3D images using a similar type of passive parallax optic will require said parallax optic to have a pitch of substantially X microns. The 50% reduction in pitch of the parallax optic is advantageous owning to the fact that smaller pitch parallax optics introduces less image artefacts in both the 2D and 3D image modes.

The use of standard sub-pixels (sub-pixels which are not split) in conjunction with a passive parallax optic may yield a display capable of showing a public wide view 2D image with a perceived resolution of 50%, and a private narrow view 2D image with a perceived resolution of 25%. The use of split sub-pixels in conjunction with a passive parallax optic may yield a display capable of showing a public wide view 2D image with a perceived resolution of 100%, and a private narrow view 2D image with a perceived resolution of 100%.

The use of standard sub-pixels (sub-pixels which are not split) in conjunction with a passive parallax optic may yield a display capable of a head tracked 4-view 3D mode with 25% resolution and a 2D mode with 25% resolution. The use of split sub-pixels in conjunction with a passive parallax optic may yield a display capable of a head tracked 4-view 3D mode with 50% resolution and a 2D mode with 25% resolution. The use of time multiplexing techniques with said split sub-pixel display can improve the perceived resolution of the 3D mode to 50%.

The use of standard sub-pixels (sub-pixels which are not split) in conjunction with a passive parallax optic may yield a display capable of showing dual view images with a perceived resolution of 50% for each image. The use of split sub-pixels and a time multiplexing technique in conjunction with a similar type of passive parallax optic may yield a dual view display capable of showing images with a perceived resolution of 100% for each image.

The means of electronically switching the viewing mode of the display is contained within the base panel of the display (i.e. the split sub-pixel arrangement with controllable voltage offset between the different sub-regions of each sub-pixel) so the additional cost of the display over a standard 2D LCD is only the cost of the additional passive optical arrangement and the one-time cost of modification to the fabrication equipment for the active matrix pixel electronics. This is preferable to the need to add complexity to the display counter substrate in order to provide the capability to apply a controllable voltage offset between the different split sub-pixel sub-regions, as described in WO2009/104816.

A multi-view display with split sub-pixels may be driven according to its native resolution, and does not require additional or higher-speed drivers. The additional complexity to drive each split sub-pixel separately is minimised, typically only requiring one additional voltage reference connection and two additional switches for each row of the display. This has minimal impact on driver size and power consumption.

Although the voltage offset between each sub-region of each sub-pixel must be controllable, this offset may be set globally across the whole of the display, so no additional pixel electronics are required over existing split sub-pixel type displays. The only modification required is that, rather than the voltage offset on all pixels of the display being fixed all the time in order produce the optimum wide-viewing characteristics for the display, the global voltage offset is variable so as to allow switching between a 100% resolution 2D mode and a second image function mode.

Although the voltage offset may be set globally across the whole display, existing split sub-pixel type displays which use a capacitively coupled drive method generally have a single storage capacitor line for each row of pixel sub-regions, i.e. two storage capacitor lines for each row of pixels for a display with two sub-regions for each pixel. As LCD displays are generally addressed row-wise, with all pixels in a row receiving a signal voltage simultaneously, and all rows being addressed within the frame time, it would therefore be possible for a display of the type of this invention to control the voltage offset applied between the different sub-regions of each pixel on each row. The display would therefore capable of displaying full resolution 2D images, and a second image function mode simultaneously in different regions of the display.

According to an aspect of the invention, a display is provided which includes a plurality of sub-pixels each split into a plurality of sub-regions, wherein each sub-pixel includes a single gate line and a single signal line, and each sub-region within a given sub-pixel includes a corresponding storage capacitor line; an optical element cooperatively combined with the plurality of sub-pixels to create distinct angularly dependent brightness functions in association with corresponding sub-regions within the sub-pixels; and control electronics configured to provide image data levels in the form of signal data voltages to each sub-region included within each sub-pixel via the gate line and signal line included within the sub-pixel; and to independently modify the signal data voltages provided to each sub-region within the sub-pixels via the corresponding storage capacitor lines whereby the display operates in accordance with at least two different image functions.

According to another aspect of the invention, the at least two different image functions are selected from among a group consisting of a public wide view 2D mode, a private narrow view 2D mode, a public wide view 3D mode, a private narrow view 3D mode, and a dual view mode.

In accordance with another aspect, the control electronics modify the signal data voltage provided to each sub-region of a given sub-pixel by a same amount via the corresponding storage capacitor lines.

In accordance with still another aspect, the control electronics modify the signal data voltage provided to each sub-region of a given sub-pixel by a different amount and in order that each sub-region of the sub-pixel has an appreciable brightness for non-zero image data levels.

According to another aspect, the control electronics modify the signal data voltage provided to at least one sub-region of a given sub-pixel by an amount such that the at least one sub-region has substantially no brightness for all image data levels.

According to still another aspect, the control electronics are configured to drive the plurality of sub-pixels in a time-multiplexed manner such that during a first time frame a first set of sub-regions of a given sub-pixel has substantially no brightness regardless of the image data level provided to the sub-pixel, and, during the first time frame a second set of sub-regions of the given sub-pixel has a brightness substantially related to the image data level provided to the sub-pixel; and, during a second time frame sequential to the first time frame the first set of sub-regions of the sub-pixel has a brightness substantially related to the image data level provided to the sub-pixel, and, during the second time frame sequential to the first time frame the second set of sub-regions of the sub-pixel has substantially no brightness regardless of the image data level provided to the sub-pixel.

In accordance with yet another embodiment, the sub-pixels each include a first sub-region and a second sub-region; the optical element includes a parallax element that has substantially the same pitch as the sub-pixels, the parallax element cooperating with the first sub-region of a given sub-pixel to produce a first angularly dependent brightness function and cooperating with the second sub-region of the sub-pixel to produce a second angularly dependent brightness function different from the first angularly dependent brightness function; and the control electronics are configured to independently modify the signal data voltages provided to the first and second sub-regions using the corresponding storage capacitor lines to produce 2D and 3D viewing modes.

According to still another aspect, the sub-pixels each include a first sub-region and a second sub-region; the optical element includes a parallax element that has substantially the same pitch as the sub-pixels, the parallax element cooperating with the first sub-region of a given sub-pixel to produce a first on-axis angularly dependent brightness function and cooperating with the second sub-region of the sub-pixel to produce a second off-axis angularly dependent brightness function different from the first angularly dependent brightness function; and the control electronics are configured to independently modify the signal data voltages provided to the first and second sub-regions using the corresponding storage capacitor lines to produce public wide view 2D and private narrow view 2D viewing modes.

According to another aspect, the sub-pixels each include a first sub-region and a second sub-region; the optical element includes a parallax element having substantially twice the pitch of the sub-pixels and, with respect to adjacent pairs of first and second sub-pixels among the plurality of sub-pixels, the parallax optic cooperating with the first sub-region of the first sub-pixel to produce a first angularly dependent brightness function, cooperating with the second sub-region of the first sub-pixel to produce a second angularly dependent brightness function, cooperating with the first sub-region of the second sub-pixel to produce a third angularly dependent brightness function and cooperating with the second sub-region of the second sub-pixel to produce a fourth angularly dependent brightness function, and further including a camera configured to track head movements and operatively coupled to the control electronics, and wherein the control electronics are configured to independently modify the signal data voltages provided to the first and second sub-regions using the corresponding storage capacitor lines to produce 2D and head tracked 3D viewing modes.

In yet another aspect, the sub-pixels each include a first sub-region and a second sub-region; the optical element includes a parallax element having substantially twice the pitch of sub-pixels, the parallax optic cooperating with the first sub-region of a first and a second sub-pixel to produce angularly dependent brightness functions for use with viewing 2D images on-axis and 3D images, and cooperating with the second sub-region of the first sub-pixel and second sub-pixel to produce angularly dependent brightness functions for use with viewing of 2D images off-axis; and wherein the control electronics are configured to independently modify the signal data voltages provided to the first and second sub-regions using the corresponding storage capacitor lines to produce 2D, private narrow 2D and 3D viewing modes

According to another aspect, the sub-pixels each include a first sub-region and a second sub-region; the optical element includes a parallax element having substantially the same pitch as the sub-pixels, the parallax optic cooperating with the first sub-region of a given sub-pixel to produce a first angularly dependent brightness function, and cooperating with the second sub-region of the sub-pixel to produce a second angularly dependent brightness function that is different from the first angularly dependent brightness function, and wherein the control electronics are configured to independently modify the signal data voltages provided to the first and second sub-regions using the corresponding storage capacitor lines to present dual views in time sequential manner.

In yet another aspect, the optical element is a parallax barrier that is made up of transmissive and non-transmissive regions, a lens array, or a combination thereof.

According to a further aspect of the invention, the sub-regions of a given sub-pixel may have substantially the same size. The sub-regions of a given sub-pixel may have different sizes.

According to a further aspect of the invention, the parallax optic may be a parallax barrier that is made up of transmissive and non-transmissive regions. The parallax optic may be made up of a lens array. The parallax optic may be made up of a parallax barrier and lens array. The parallax optic may be periodic in one dimension. The parallax optic may be periodic in two dimensions. The lens elements may focus light into a plane (cylindrical lenses) or to a point (spherical lenses).

According to a further aspect of the invention, the liquid crystal display device may be one of a transmissive device, a reflective device and a transflective device.

According to a further, the pitch of the structure on the parallax optic may be chosen to enable even viewing of images across the extent of the image panel display for a user situated about the central axis of the display.

To the accomplishment of the foregoing and related ends, the invention, then, includes the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF DRAWINGS

In the annexed drawings, like references indicate like parts or features:

FIG. 1a is a front view of a conventional autostereoscopic 3D display with parallax barrier;

FIG. 1b is a cross-sectional side view of the conventional autostereoscopic 3D display with parallax barrier shown in FIG. 1a;

FIG. 2a is a front view of a conventional autostereoscopic 3D display with lens array;

FIG. 2b is a cross-sectional side view of the conventional autostereoscopic 3D display with lens array shown in FIG. 2a;

FIG. 3a is a schematic view of a capacitively coupled driven split sub-pixel type multi-view display in accordance with an exemplary embodiment of the present invention;

FIG. 3b is a schematic view of a capacitively coupled driven split sub-pixel type multi-view display in accordance with another exemplary embodiment of the present invention;

FIG. 4a shows a circuit layout for a capacitive coupled split sub-pixel in accordance with an exemplary embodiment of the invention;

FIG. 4b represents the equivalent circuit of the capacitive coupled split sub-pixel shown in FIG. 4a;

FIG. 4c is a timing diagram illustrating an exemplary driving scheme in accordance with an exemplary embodiment of the present invention;

FIG. 5a represents a Voltage-Luminance response characteristic of a typical LC display;

FIG. 5b illustrates how a capacitively coupled drive method takes advantage of the Voltage-Luminance response characteristic of a LC display;

FIG. 6a represents using a V_{CS} voltage to shift an entire range in a positive direction along the Voltage-Luminance response characteristic of a LC display;

FIG. 6b represents using a V_{CS} voltage to shift an entire range in a negative direction along the Voltage-Luminance response characteristic of a LC display;

FIG. 7 illustrates a standard sub-pixel;

FIG. 8 represents a split sub-pixel according to an exemplary arrangement of the present invention;

FIG. 9 represents a split sub-pixel according to another exemplary arrangement of the present invention;

FIG. 10 represents a split sub-pixel in accordance with another exemplary arrangement of the present invention;

FIG. 11 schematically represents two standard sub-pixels and optics for creating autostereoscopic 3D images in a conventional display;

FIG. 12 schematically represents split sub-pixels and optics for creating 2D images according to a first embodiment of the present invention;

FIG. 13 schematically represents split sub-pixels and optics for creating first frame autostereoscopic 3D images in the first embodiment of the present invention;

FIG. 14 schematically represents split sub-pixels and optics for creating second frame autostereoscopic 3D images in the first embodiment of the present invention;

FIG. 15 schematically represents split sub-pixels and optics for creating 2D images according to a second embodiment of the present invention;

FIG. 16 schematically represents split sub-pixels and optics for creating first frame autostereoscopic 3D images in the second embodiment of the present invention;

FIG. 17 schematically represents split sub-pixels and optics for creating second frame autostereoscopic 3D images in the second embodiment of the present invention;

FIG. 18 schematically illustrates split sub-pixels and optics for creating 2D images in a 4 view head tracked system according to a third embodiment of present invention;

FIG. 19 schematically represents split sub-pixels and optics for creating first frame autostereoscopic 3D images in a 4 view head tracked system according to the third embodiment of the present invention;

FIG. 20 schematically represents split sub-pixels and optics for creating second frame autostereoscopic 3D images in a 4 view head tracked system according to the third embodiment of the present invention;

FIG. 21 represents an asymmetric split sub-pixel according to another exemplary arrangement of the present invention;

FIG. 22 schematically represents split sub-pixels and optics for creating 2D images according to a fourth embodiment of the present invention;

FIG. 23 schematically illustrates split sub-pixels and optics for creating 2D images in a private mode (on-axis view) according to the fourth embodiment of the present invention;

FIG. 24 schematically illustrates split sub-pixels and optics for creating 2D images in private mode (off-axis view) according to the fourth embodiment of the present invention;

FIG. 25 represents another asymmetric split sub-pixel according to an exemplary arrangement of the present invention;

FIG. 26 schematically represents split sub-pixels and optics for creating autostereoscopic 3D images and 2D images in private mode (on-axis view) according to a fifth embodiment of the present invention; and

FIG. 27 schematically represents split sub-pixels and optics for creating 2D images in non-private mode (off-axis view) in accordance with the fifth embodiment of the present invention.

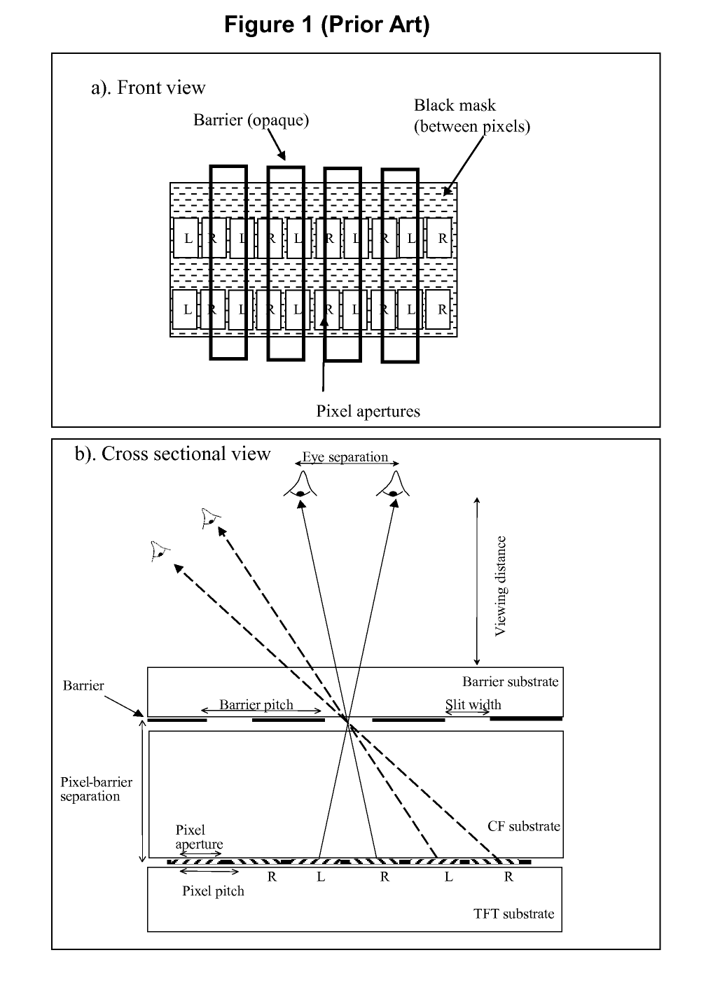

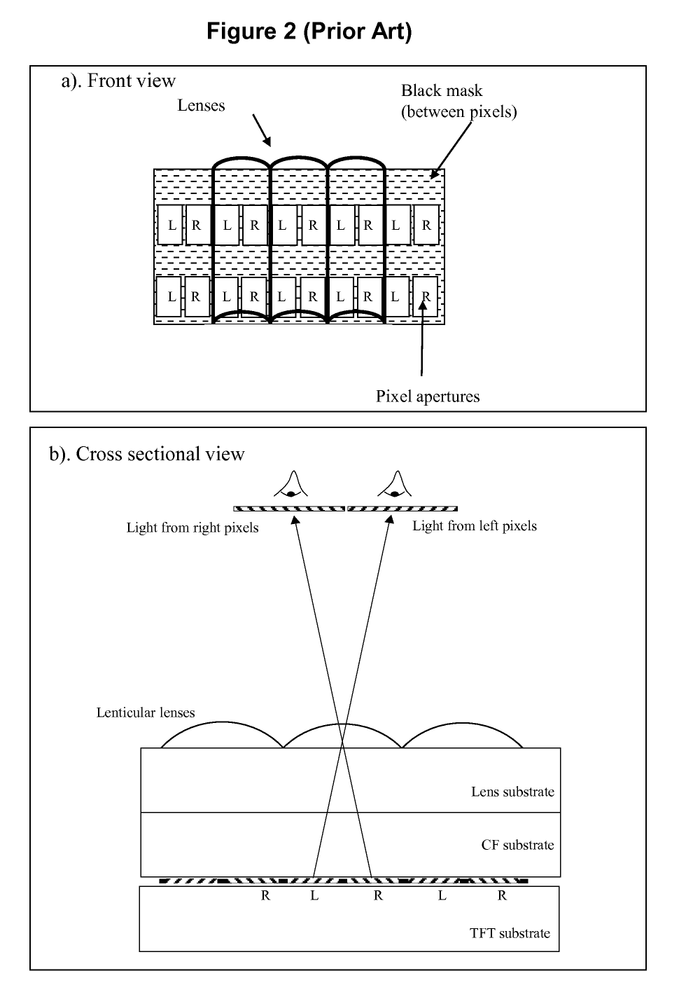

### DETAILED DESCRIPTION OF INVENTION

The present invention is now described with reference to the figures, wherein like reference numerals are used to refer to like elements throughout.

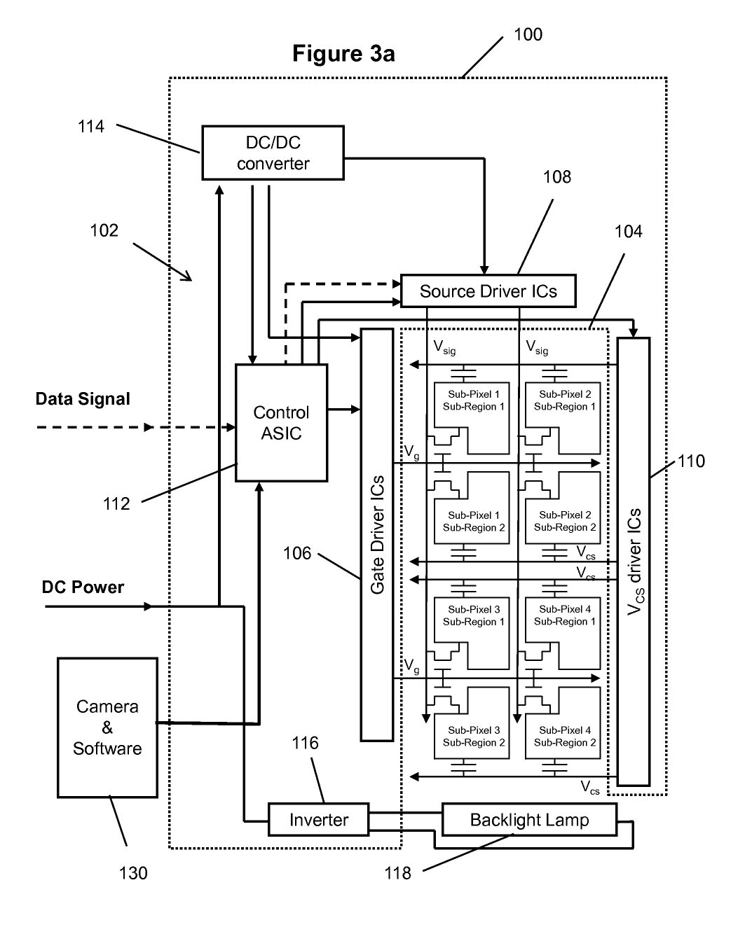

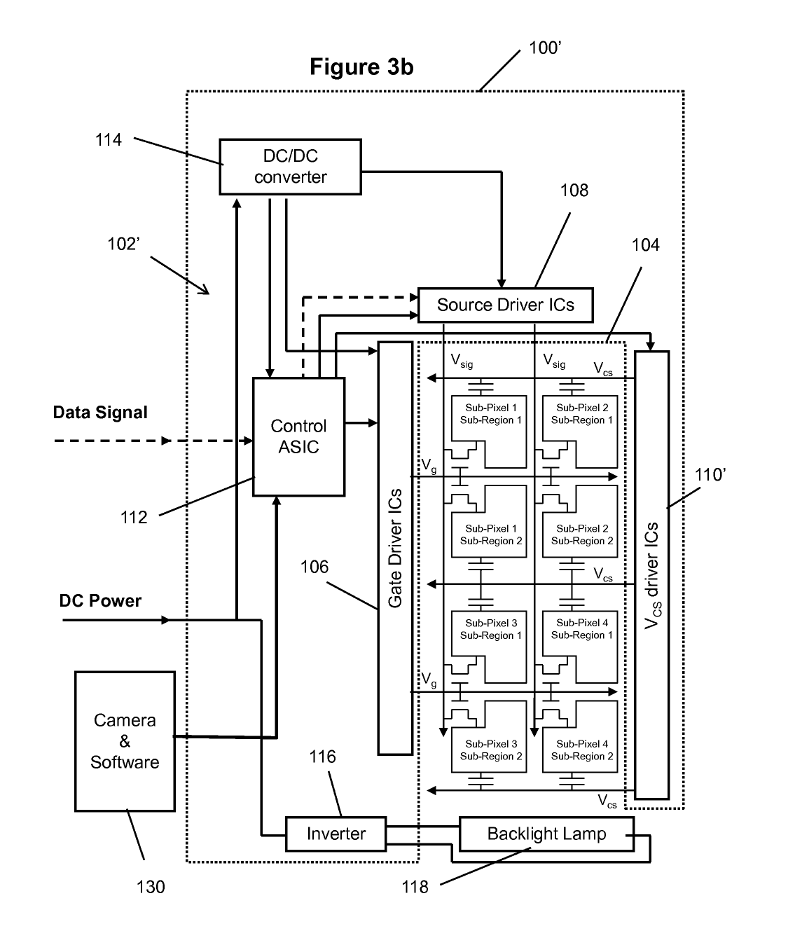

FIG. 3a illustrates a schematic of capacitively coupled driven split sub-pixel type multi-view display 100 in accordance with an exemplary embodiment of the present application. The display 100 includes control electronics 102 and a liquid crystal (LC) display panel 104. The control electronics 102 are designed, as conventional, to receive digital image data and to output analogue signal voltages for each pixel included in the liquid crystal (LC) panel 104. In addition, the control electronics 102 provide timing pulses and a common voltage for the counter electrode of all the pixels in the LC panel 104.

More particularly, the control electronics 102 are configured specifically to the electro-optical characteristics of the LC panel 104 so as to output signal voltages which are dependent on the input image data in such a way as to optimise the perceived quality of the displayed image, i.e. resolution, contrast, brightness, response time etc, for the principal viewer observing from a direction normal to the display surface (on-axis). The relationship between the input image data value for a given pixel and the observed luminance resulting from the display (gamma curve) is determined by the combined effect of the data-value to signal voltage mapping of the display driver, and the signal voltage to luminance response of the LC panel 104.

The control electronics 102 include a gate driver 106 which provides gate control voltages to the LC panel 104 via gate lines Vg, and a source driver 108 which outputs signal data voltages (image data levels) to the pixels via source signal lines Vsig. The control electronics 102 further include a storage capacitor line driver 110 for driving the pixels by modulating the voltages on storage capacitor lines Vcs in accordance with the present invention as described herein.

A control application specific integrated circuit (ASIC) 112 receives the image data signal to be displayed and provides corresponding data voltages and timing signals to the gate driver 106, source driver 108 and storage capacitor line driver 110 as described herein. The display 100 further includes a DC/DC converter 114 for providing the necessary dc voltages, and an inverter 116 which provides power to backlight lamp 118.

As is described in more detail below, the display 100 further includes an optical element 6 (not shown in FIG. 3a) such as a parallax optic or lens array. Each pixel in the LC panel 104 is made up of sub-pixels (e.g., sub-pixels 1-4 as shown in FIG. 3a). The sub-pixels are split to form split sub-pixels each having a plurality of sub-regions (e.g., sub-regions 1 and 2), although it will be appreciated that other configurations of split sub-pixels are equally applicable. The optical element is cooperatively combined with the sub-pixels to create distinct angularly dependent brightness functions in association with the corresponding sub-regions within the sub-pixels.

In capacitively coupled driven split sub-pixel displays of the type described in the prior art, the modulation of the voltage on the V_{CS} lines has been limited to applying signals to the V_{CS} lines for the first and second sub-regions for each sub-pixel with a fixed difference, so as to produce a fixed offset in the voltage on each split sub-pixel sub-region for optimum wide-viewing angle characteristics.

In the first embodiment of this invention, the control electronics 102 as shown in FIG. 3a differ from such prior art in that the control electronics are modified so that the V_{CS} driver 110 may selectively apply a variety of signals to the different split sub-pixel sub-regions so as to fully control the voltage difference between the two sub-regions of a given split sub-pixel. When combined with the aforementioned optical element embodiments of this invention, the ability to independently control or modify the voltage (and hence the luminance) on each sub-region of a given sub-pixel enables the display 100 to switch between a public wide view 2D mode and at least a second viewing mode, for example, an autostereoscopic 3D.

A display 100′ in accordance with a further exemplary embodiment of the present invention is illustrated in FIG. 3b. The embodiment of FIG. 30 differs in substantive part from that of FIG. 3a in that the embodiment of FIG. 3b has half the number of the storage capacitor V_{CS} lines. In essence, the storage capacitor line driver 110′ shares a single V_{CS} line between two neighboring sub-pixels. A reduced number of V_{CS} lines is an advantage in terms of simplifying the storage capacitor line driver 110′ and improving the aperture ratio of each pixel.

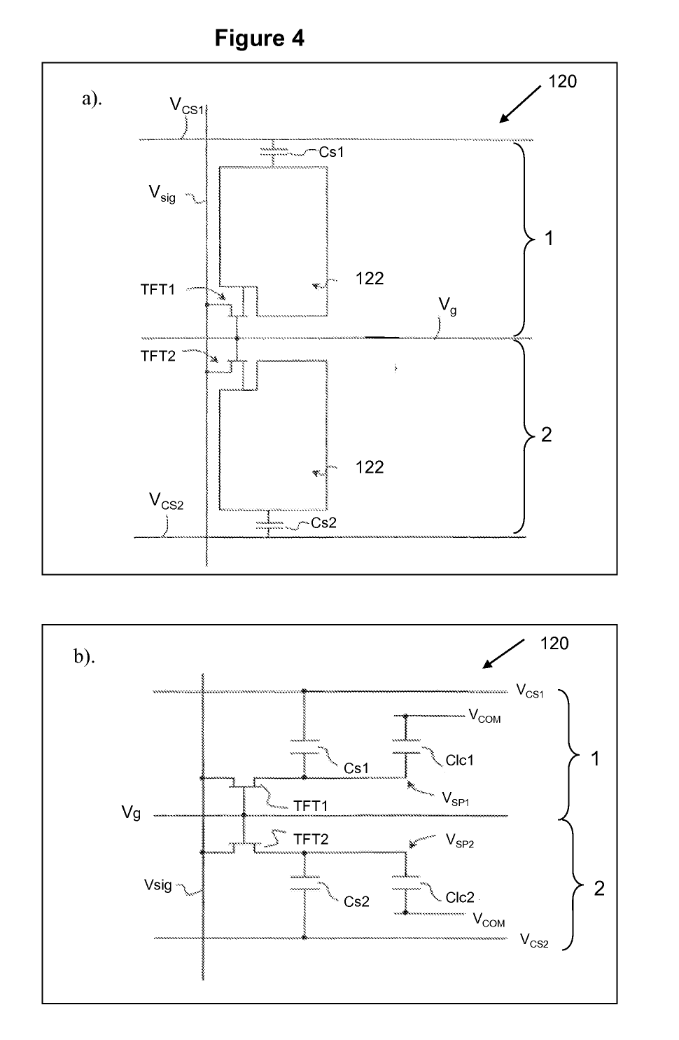

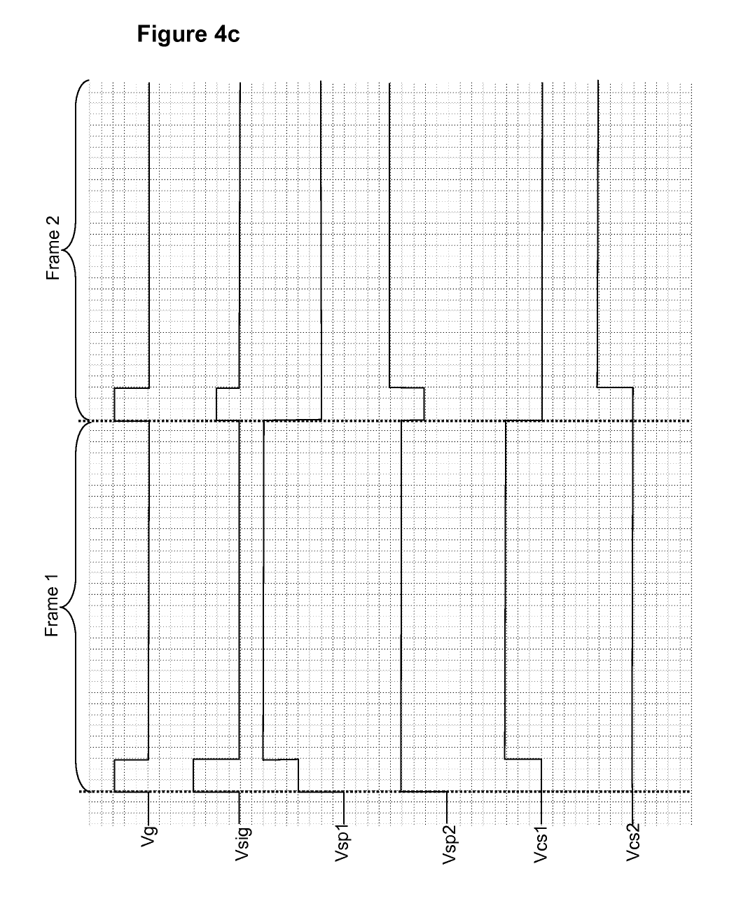

FIGS. 4a and 4b illustrate in more detail an exemplary split sub-pixel arrangement in accordance with the present invention as exemplified in the embodiments of FIGS. 29 and 30. FIG. 4a shows a given sub-pixel 120 included within the LC panel 104. Each sub-pixel 120 is split into first and second sub-pixel sub-regions 1 and 2, respectively. The electrode 122 for each sub-region is coupled to a common gate line Vg via a respective TFT (e.g., TFT₁ and TFT₂), and to a corresponding storage capacitor line Vcs (e.g., Vcs1 and Vcs2) via respective storage capacitors (e.g., Cs1 and Cs2). FIG. 4b illustrates each sub-region 1, 2 by its electrical equivalent, namely capacitance C_{lc1} and C_{lc2}, respectively. As is well known, the liquid crystal material between the pixel electrode 122 and the common electrode, represented by Vcom, may be considered as a capacitance Clc. As described herein, V_{SP} is the voltage on the TFT side of the split pixel and V_{COM} is the voltage on the non-TFT side of the split pixel. Assuming standard LCD operation, V_{COM} is the same for all sub-regions of all split sub-pixel. V_{LC} is the potential difference between V_{SP} and V_{COM}.

Typical optical embodiments of this invention relate to the combination of a parallax optic type optical element with a pixellated image display provided via the LC panel 104 to create a set of angularly dependent viewing zones, each representing its own respective angularly dependent brightness function, for the display's sub-pixels (i.e. a multi-view display). Image data is presented to the sub-pixels included within the LC panel 104 by the gate driver 106 and source driver 108 using suitable addressing, and suitable voltage application to sub-pixel sub-region storage capacitors (e.g., Cs1 and Cs2) is provided via the storage capacitor line driver 110, so as to realize a display that has a public wide view 2D mode and at least one further image function mode. The further image function mode may include, but is not limited to, a private narrow view mode, an autostereoscopic 3D mode, a private autostereoscopic 3D mode (private viewing of 3D images) and a dual view mode. In the public wide view mode, the displayed image is viewable from all directions. In the private narrow view mode, an image is substantially viewable about an axis normal to the display. In the autostereoscopic 3D mode (hereafter 3D mode), an image is displayed that is perceived to have depth; thus a three dimensional image is also realised. In the dual view mode, a first image is displayed substantially to the left of the display while a second image, that is independent of the first image, is displayed substantially to the right of the display.

In a preferred embodiment, the split sub-pixel type LCD display control electronics 102,102′ drive the sub-pixel sub-regions 1,2 by a capacitive coupling method similar in part to that described in EP00336570A1. The display 100,100′ is characterised by having the capability to provide a single signal data voltage to all sub-regions (e.g., sub-regions 1 and 2) of each split sub-pixel 120 of the display 100.100′ during an addressing period within each frame period, and then following the addressing period, but still within the same frame period, having the capability to apply an individually controllable offset to the voltage on the different sub-regions 1,2 of the split sub-pixels 120 by applying individually controllable voltages to the storage capacitor lines V_{CS} of the different split sub-pixel sub-regions.

The sequence of addressing voltages applied to each sub-pixel 120 in the display 100,100′ may be as follows, with reference to voltages as labeled in FIGS. 4a, 4b and 4c. Each row of sub-pixels is activated sequentially within the frame time. A row is activated by the application of a gate voltage signal to the gate line V_{g} of that row which switches the thin film transistors TFT₁ and TFT₂ of all the sub-pixels of that row into a conducting state. The signal data voltage for each sub-pixel in the active row is then produced by the control electronics 102,102′ and directed to each sub-pixel via the corresponding data signal source line V_{sig} from the source driver 108. The storage capacitors C_{S1} and C_{S2}, and liquid crystal cell capacitors C_{LC1} and C_{LC2} of each sub-pixel are then charged to their signal data voltage provided via the source signal line V_{sig}. Once this charging has occurred, the activation signal on the gate line V_{g} is removed by the gate driver 106, turning off the TFTs (e.g., TFT₁ and TFT₂) and substantially isolating the charge on each sub-pixel sub-region 1,2. The voltages on the sides of the storage capacitors C_{S1} and C_{S2} opposite the sub-pixel electrodes 122, V_{CS1} and V_{CS2} respectively, are then altered so as to capacitively couple to the voltage on each sub-pixel sub-region 1,2 and offset it by the amount required to result in the intended potential difference being applied across the liquid crystal layer (V_{LC}) of each sub-pixel region 1,2, i.e. between V_{SP1} and V_{COM}, and V_{SP2} and V_{COM}, for the remainder of the frame time. Consequently, the voltage on V_{SP1} and V_{SP2} may be the same so that the luminance on split sub-pixel regions 1 and 2 are substantially the same—this mode of operation would typically be associated with a first public wide view mode. Alternatively, the voltage on V_{SP1} and V_{SP2} may be different so that the luminance on split sub-pixel region 1 and 2 are different but non-zero for all non-zero signal voltages—this mode of operation would typically be associated with a second public wide view mode that has different angular dependent viewing characteristics relative to the first public wide view mode. Alternatively, the voltage on V_{SP1} and V_{SP2} may be different so that the luminance on a given split sub-pixel region (region 1 for example) is non-zero for all non-zero signal voltages while the luminance on a further region of said split sub-pixel (region 2 for example) is zero for all signal voltages—this mode of operation would typically be associated with a further image function mode, such as an autostereoscopic 3D mode, privacy mode etc.

FIG. 4c illustrates that in time frame 1, the voltage on V_{CS2} is approximately zero while V_{CS1} has a non-zero value. Consequently the voltage V_{SP1} on split sub-pixel region 1 is larger than the voltage V_{SP2} on region 2 of said split sub-pixel. In turn, the luminance of split sub-pixel region 1 is greater than that of split sub-pixel region 2. In time frame 1, the luminance of split sub-pixel region 2 may be zero. The display device may be operated such that for a number of frames determined by the user subsequent to time frame 1, the voltage on V_{CS2} is substantially zero and hence the luminance of split sub-pixel region 2 may be zero i.e. the driving scheme of frame 1 prevails until a control command is received from the user. Alternatively, a time multiplexed drive scheme may be realised. In the time multiplexed drive scheme, time frame 2 is used subsequent to time frame 1 such that the voltage on V_{CS1} is substantially zero while a non-zero voltage is applied to Vcs2 and therefore split sub-pixel region 2 has a larger luminance than split sub-pixel region 1 for time frame 2. In the time multiplexed drive scheme, frame 1 follows frame 2 which follows frame 1 etc. until a control command is issued by the user. The time multiplexed scheme has advantages in terms of increasing the perceived resolution of the displayed image.

It will be appreciated that FIG. 4c is only a schematic for illustrative purposes. A detailed description of the required timings and magnitudes of these addressing voltages to produce the desired effect is given in EP00336570A1, with the key distinction being that in the present invention multiple V_{CS} lines are present per sub-pixel, each coupling to a different split sub-pixel sub-region 1,2 within the sub-pixel, and the offset voltages on those different V_{CS} lines are individually controllable via the storage capacitor line driver 110,110′.

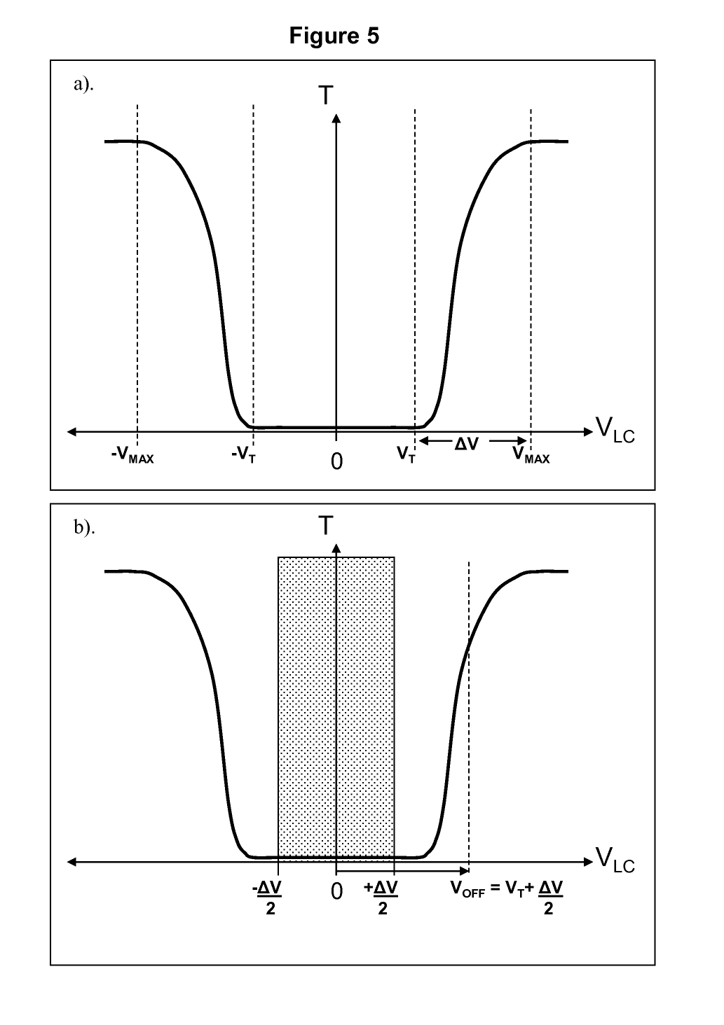

Conventionally, the capacitively coupled driving method was used to minimise the voltage range which the signal voltages have to span in order to drive the LC layer from fully off (substantially no luminance) to fully on (substantially maximum luminance), and also allow the polarity of the voltage applied across each pixel to be reversed in sequential frame periods with reduced power consumption. The manner in which this is achieved is illustrated in FIGS. 5a and 5b. FIG. 5a shows the voltage transmission curve of a typical LC cell, the x-axis V_{LC} being the potential difference across the LC layer (i.e. between V_{SP} and V_{COM} as represented in FIG. 4b), and the y-axis being transmission of light through the cell. As can be seen, no transmission occurs with increasing V_{LC} until a threshold voltage V_{T} is reached, at which point the coupling of the LC director to the applied field begins to overcome the elastic constants of the LC material, and a director deformation is induced. As V_{LC} is increased further, the reorientation of the LC director due the applied field increases further, resulting in increased transmission, until a point is reached at V_{MAX}, where the LC has deformed fully to comply with the applied field and no further increase in transmission can be obtained. The total range of drive voltages required in order to drive the LC cell from fully black to fully transmitting is therefore ΔV=V_{MAX}−V_{T}. FIG. 5b illustrates how the capacitively coupled drive method takes advantage of this to write the data signal voltage for all pixels in the range

$$- \frac{Δ V}{2} to + \frac{Δ V}{2}$$

only, then once this reduced magnitude signal voltage is written to the pixel, the voltage V_{CS} applied to the storage capacitor line of the pixel is altered so as to offset the voltage on V_{SP} by an amount

$${V}_{OFF} = {V}_{T} + \frac{Δ V}{2} ,$$

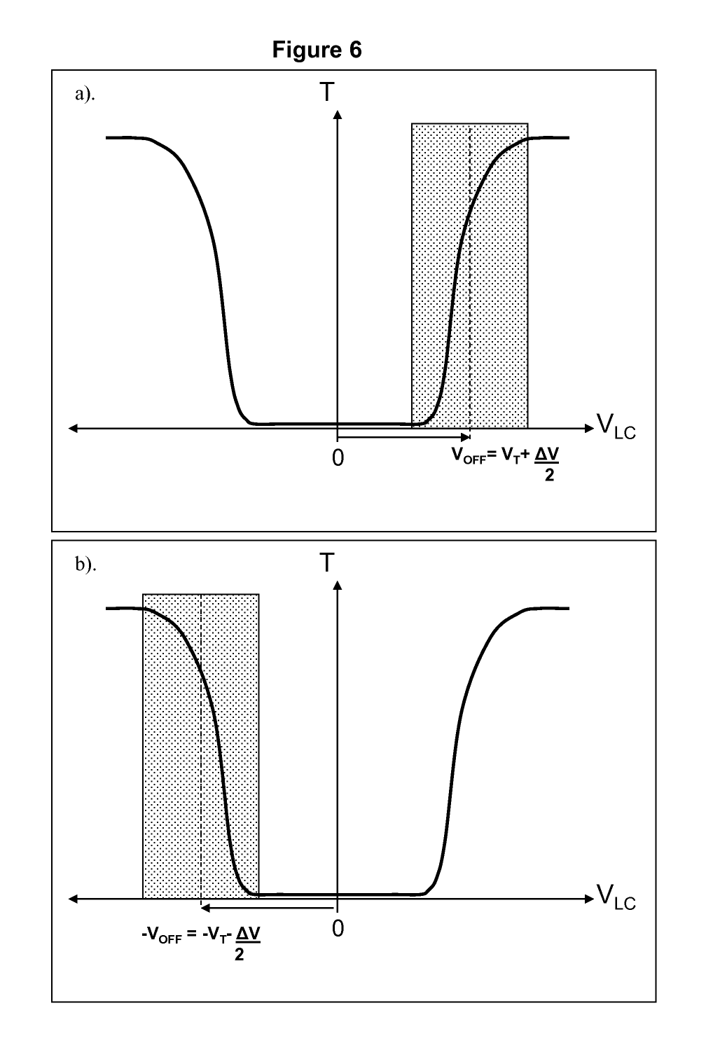

shifting the signal voltage into the range where it will cause the required transmission of light through the pixel. In sequential frames, the data signal for each pixel and the polarity of V_{OFF} may be inverted, in order to d.c. balance the voltage across the LC layer over time. This saves having to invert the polarity of the voltage on the LC counter electrode plate, V_{COM}, every frame, which has a large capacitance and therefore would draw more power. This method of writing the data voltage within a range approximately equal in width to the range over which the LC layer fully switches, but centered on zero volts, then using the V_{CS} voltage to shift the entire range in either the positive or negative direction to the point where it covers the LC switching range voltages, is shown in FIGS. 6a and 6b.

In the driving scheme of the display 100,110′ according to the present invention, a different V_{OFF} may be applied to the different sub-regions 1,2 of each sub-pixel 120. In the 2D mode, the V_{OFF} applied to the different sub-regions via the storage capacitor line driver 110,110′ may be substantially equal, so that the sub regions 1,2 of each sub-pixel 120 transmit effectively the same brightness, or a relatively small difference in V_{OFF} may be applied so as to improve the wide-angle viewing properties of the sub-pixel. The differences in transmission required from the different sub-regions in order to optimise the wide viewing properties of the sub-pixel are described in more detail in U.S. Pat. No. 7,079,214.

In the directional display mode (i.e. the private mode, the 3D mode, private 3D mode) of the display 100, 100′ in accordance with the present invention, one of the sub-pixel sub-regions (e.g., sub-region 1) may receive the same V_{OFF} as it would in the 2D mode, while the other sub-region (e.g., sub-region 2) receives a V_{OFF} of zero. In this way, although the same data voltages are written to all the sub-regions 1,2 via the source signal line Vsig, if the threshold voltage of the LC cell is greater than half the voltage driving range

$$( {V}_{T} \geq \frac{Δ V}{2} ) ,$$

sub-regions with a V_{OFF} of zero applied to them will produce substantially no transmission. In this way, a portion of the sub-regions comprising each independently addressable pixel may be selectively switched off (e.g., zero luminance).

The ability to selectively switch off a portion of the sub-regions 1,2 of each sub-pixel 120 in the display 100, 100′, despite the sub-regions 1,2 being addressed with the same signal voltage during the data writing period of the frame time, when combined with a passive parallax optic which directs light from the different sub-regions to different angular viewing ranges, allows the display 100,100′ to be switched between different viewing modes. The display 100,100′ therefore has the capability of displaying 100% resolution 2D images in one mode and a further, directional display mode, by simply changing the difference in voltage applied to the different storage capacitor lines Vcs for each sub-pixel sub-region.

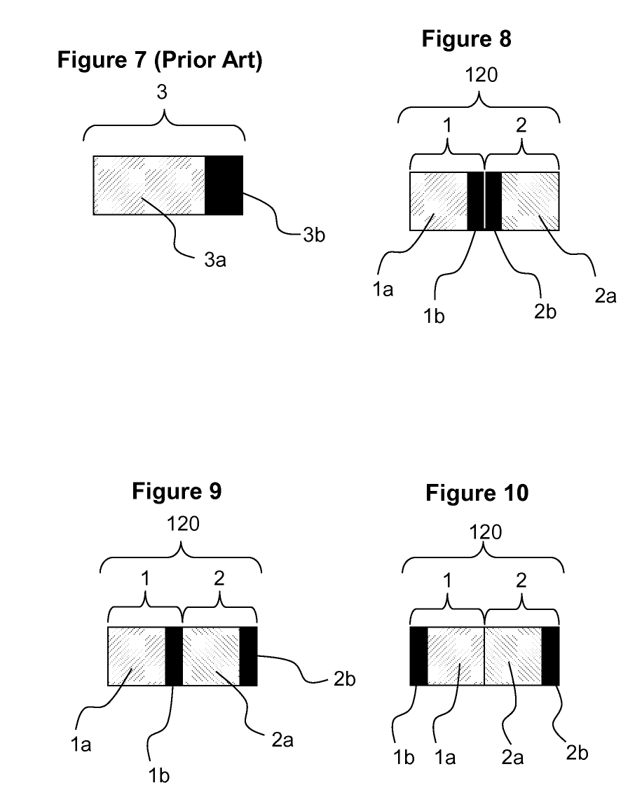

With reference to FIG. 7, a conventional sub-pixel 3 in a liquid crystal display is comprised of a region for light modulation 3a and a region of electronics 3b that controls the light modulation region 3a. The light modulation region 3a may be further sub-divided into regions that modulate the amount of light transmitted through the LCD and regions that modulate the amount of light reflected from the LCD. In some cases, the region that modulates light reflected from the LCD is situated on top of the electronics region 3b.

FIGS. 8, 9 and 10 illustrate different exemplary embodiments of a sub-pixel 120 for use in a display 100, 100′ in accordance with the present invention. In each embodiment, the sub-pixel 120 is comprised of two sub-regions 1 and 2, although it will be appreciated that the sub-pixel 120 may include any number of sub-regions without departing from the scope of the invention. The regions 1 and 2 are further divided in two sub-regions for light modulation 1a and 2a, and, two sub-regions of electronics 1b and 2b that control the light modulation sub-regions 1a and 2a respectively. The light modulation sub-regions 1a and 2a may be further divided into partial sub-regions (not shown) that modulate the amount of light transmitted through the LC panel 104 and partial sub-regions that modulate the amount of reflected light from the LC panel 104. In some cases, the partial sub-regions that modulate light reflected from the LC panel 104 are situated on top of the electronics region 1b, 2b. FIGS. 8-10 all describe split-sub pixel systems which are differentiated from each other via the location of the light modulation sub-regions, 1a and 2a, and the electronic control sub-regions 1b and 2b.

The display 100,100′ may be comprised entirely of split sub-pixels 120 as illustrated in FIG. 8, 9 or 10. Alternatively, the display 100,100′ may be comprised of a mixture of split sub-pixels, sub-pixels and/and or standard pixels. If the display is a monochrome display then that display may be comprised of split pixels. In general, a display may be comprised of two or more different types of standard and split sub-pixel pixel arrangements such as those shown in FIGS. 7-10.

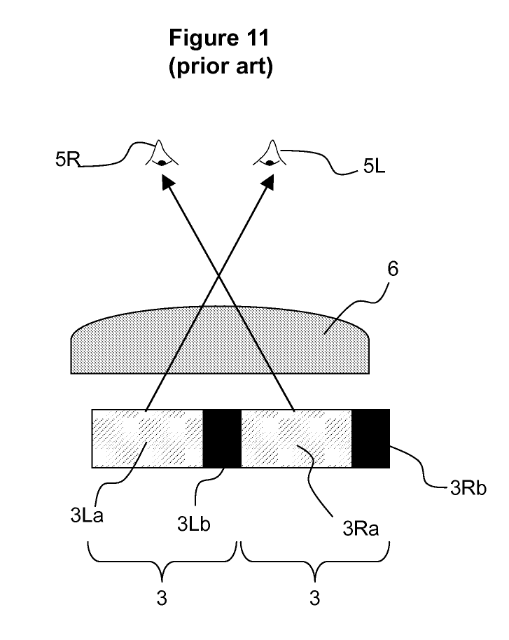

FIG. 11 illustrates a conventional arrangement wherein an optical element 6 with a pitch that is substantially twice that of a standard sub-pixel 3 is used to create two angularly dependent viewing windows for light modulation region 3La and light modulation region 3Ra. The display user receives information to the left eye 5L from pixel region 3La and information to the right eye 5R from 3Ra. The optical element 6 may be, for example, a lens array, a parallax barrier array or a combination of lens and parallax barrier elements. If the optical element is passive (not switchable), then the resolution of 2D images and 3D image are 50% of the native display resolution (i.e. 50% of the display resolution with no optical element 6 attached).

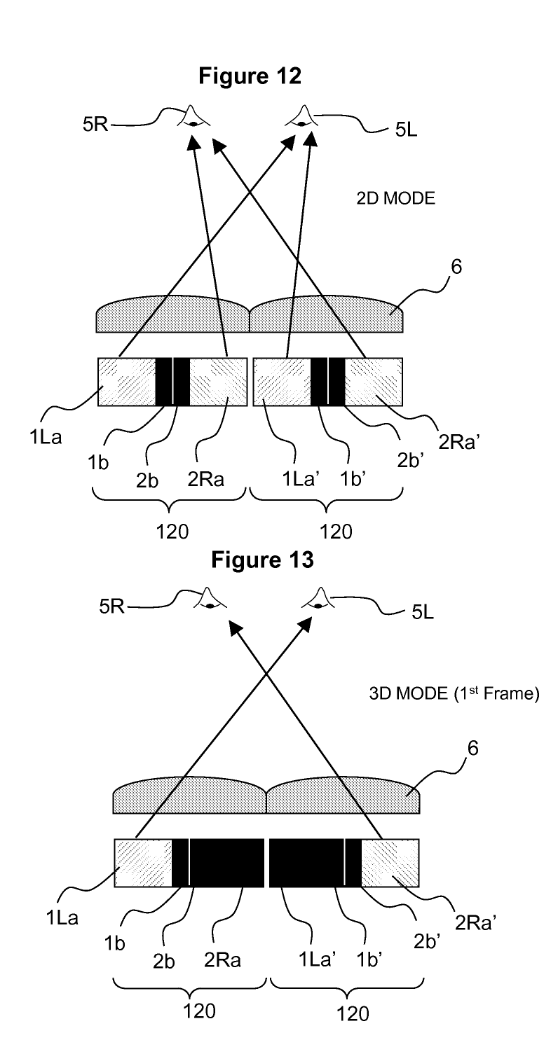

FIG. 12 illustrates an arrangement of an optical element 6 in conjunction with the sub-pixels 120 in accordance with the present invention. As shown in FIG. 12, an optical element 6 with a pitch that is substantially the same as a split sub-pixel 120 is used to create a first angularly dependent viewing window for light modulation regions 1La and 1La′ and a second angularly dependent viewing window, that is different from the first, for light modulation regions 2Ra and 2Ra′. The split sub-pixel arrangement in FIG. 12 is based on that from FIG. 8. However, other split sub-pixel arrangements such as those shown in FIGS. 9 and 10 are all interchangeable for use in FIG. 12.

With reference to FIG. 12, the display user receives information to the left eye 5L from sub-pixel sub-regions 1La and 1La′ and information to the right eye 5R from pixel sub-regions 2Ra and 2Ra′. The optical element 6 may be, for example, a lens array, a parallax barrier array or a combination of lens and parallax barrier elements.

With reference to FIG. 12, for the display of 2D images, the drive voltages may be applied to both sub-regions 1,2 of a split sub-pixel 120 (for example, 1La and 2Ra) such that each sub-region 1,2 has substantially the same brightness.

Alternatively, with reference to FIG. 12, for the display of 2D images the drive voltages may be applied to both sub-regions 1,2 of a split sub-pixel 120 (for example, 1La and 2Ra) such that the luminance of the dimmest sub-region (for example, 1La) is >50% of the brightest sub-region (for example, 2Ra). As discussed previously and in the prior art, this method of driving can be used to improve the off-axis colour reproduction of the 2D images. FIG. 12 clearly demonstrates that the user receives information to both eyes from the same split sub-pixel 120 and consequently the resolution of the 2D mode is 100% of the native LCD panel.

For the display of 3D images using a split sub-pixel scheme, the drive voltages may be applied such that 50% of each pixel (i.e. 50% of the sub-regions) has substantially no luminance while the other 50% of the pixel sub-regions have a luminance related to the respective eye data associated with an autostereoscopic 3D image. FIG. 13 illustrates the embodiment of FIG. 12 when driven in the 3D mode. More particularly, sub-region 1La has a luminance related the left eye data of an autostereoscopic 3D image while sub-region 2Ra has substantially no luminance (i.e. is switched black). Sub-region 2Ra′ has a luminance related the right eye data of an autostereoscopic 3D image while sub-region 1La′ has substantially no luminance (i.e. is switched black). Referring briefly back to FIGS. 4a and 4b, this significant difference in luminance for the two sub-regions of the same sub-pixel is achieved via the application of a suitable voltage to V_{CS1} and V_{CS2} by the storage capacitor line driver 110,110′. According to FIG. 13, the resolution of the 3D image is 50%. Again, the split sub-pixel arrangement in FIGS. 12 and 13 originates from the arrangement shown in FIG. 8. However, other split sub-pixel arrangements such as those shown in FIG. 9 and FIG. 10 are all interchangeable for use in the embodiment of FIGS. 12 and 13.

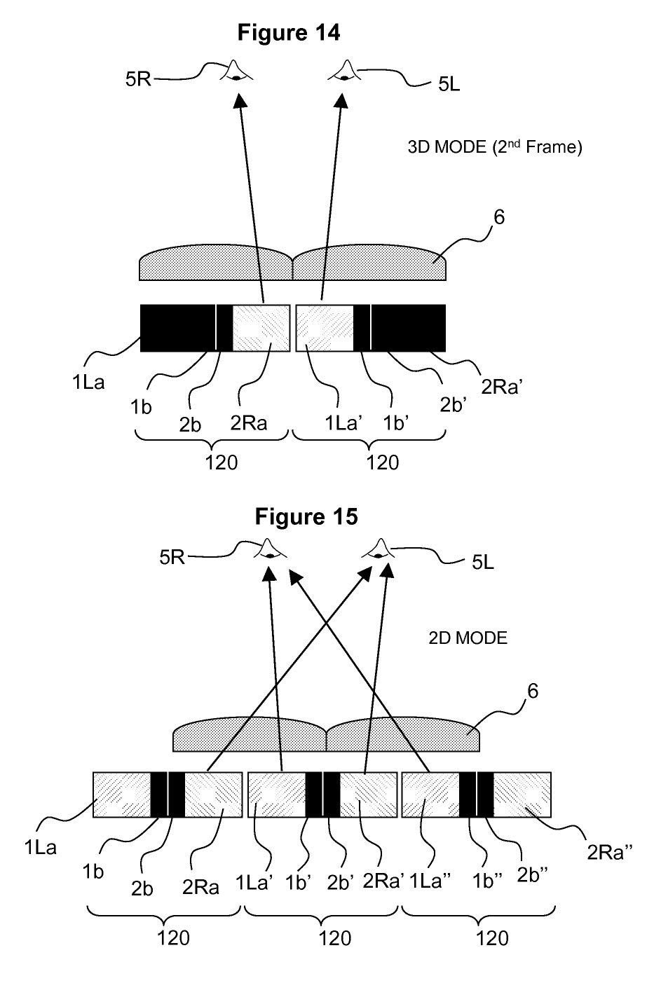

FIG. 14 illustrates an alternate autostereoscopic 3D mode compared to that of FIG. 13. In FIG. 14, sub-region 2Ra has a luminance related the right eye data of an autostereoscopic 3D image while sub-region 1La has substantially no luminance (i.e. is switched black). Sub-region 2La′ has a luminance related the left eye data of an autostereoscopic 3D image while sub-region 2Ra′ has substantially no luminance (i.e. is switched black). Again referring briefly back to FIGS. 4a, 4b and 4c, this significant difference in luminance for the two sub-regions of the same sub-pixel 120 is achieved via the application of a suitable voltage to V_{CS1} and V_{CS2} by the storage capacitor line driver 110,110′. According to FIG. 14, the resolution of the 3D image is again 50%.

FIG. 4c, FIG. 13 and FIG. 14 demonstrate that the 3D mode can be achieved in two distinct ways. Consequently, a time multiplexed scheme for display of 3D images can be realised using the details contained within FIG. 13 for a first display frame and using the details contained within FIG. 14 for a second display frame that is sequential to the first. By alternating display frames between the scheme used in FIG. 13 and FIG. 14, a 3D image of 100% resolution can be realised.

With reference to the embodiment of FIGS. 12-14, a display with the capability to show autostereoscopic 3D images can be achieved with parallax optic 6 comprised entirely of a lens array that is adhered to the uppermost surface of a display device with glue. The parallax optic 6 is centered symmetrically about the light modulation regions 1La and 2Ra of the same sub-pixel. The dimensions of the sub-pixel 4 are: width 1La=30 μm, width 1b=20 μm, width 2b=20 μm, width 2Ra=30 μm. Total sub-pixel width=100 μm. The lens has the following parameters: pixel to lens apex distance=450 μm, lens width=100 μm, lens radius 230 μm. The values and ratio of values described above are exemplary of a system capable of displaying autostereoscopic 3D images.

FIG. 15 illustrates an embodiment in which an optical element 6 with a pitch that is substantially the same as a split sub-pixel 120 is used to create a first angularly dependent viewing window for light modulation regions 1La′ and 1La″ and a second angularly dependent viewing window, that is different from the first, for light modulation regions 2Ra and 2Ra′. The split sub-pixel arrangement in FIG. 15 is based on the configuration of FIG. 8. However, again it will be appreciated that other split sub-pixel arrangements such as those shown in FIGS. 9 and 10 are all interchangeable for use in FIG. 15. The display user receives information to the left eye 5L from sub-pixel sub-regions 2Ra and 2Ra′ and information to the right eye 5R from sub-pixel sub-regions 1La′ and 1La″. The optical element 6 may be, for example, a lens array, a parallax barrier array or a combination of lens and parallax barrier elements. The operation of FIG. 15 is essentially the same as FIG. 12 except that the optical element 6 and the array of split sub-pixels 120 have been off-set from each other by an amount substantially equal to half the pitch of the optical element 6.

With reference to FIG. 15, for the display in the 2D mode, the drive voltages may be applied to both sub-regions 1,2 of a split sub-pixel 120 (for example, 1La′ and 2Ra′) such that each sub-region (for example, 1La′ and 2Ra′) has substantially the same brightness. Alternatively, with reference to FIG. 15, for the display of 2D images the drive voltages may be applied to both sub-regions 1,2 such that the luminance of the dimmest sub-region (for example, 1La′) is >50% of the brightest sub-region (for example, 2Ra′). As discussed previously, this method of driving can be used to improve the off-axis colour reproduction of the 2D images. FIG. 15 clearly demonstrates that the user receives information to both eyes from the same split sub-pixel 120 and consequently the resolution of the 2D mode is 100% of the native LC panel 104.

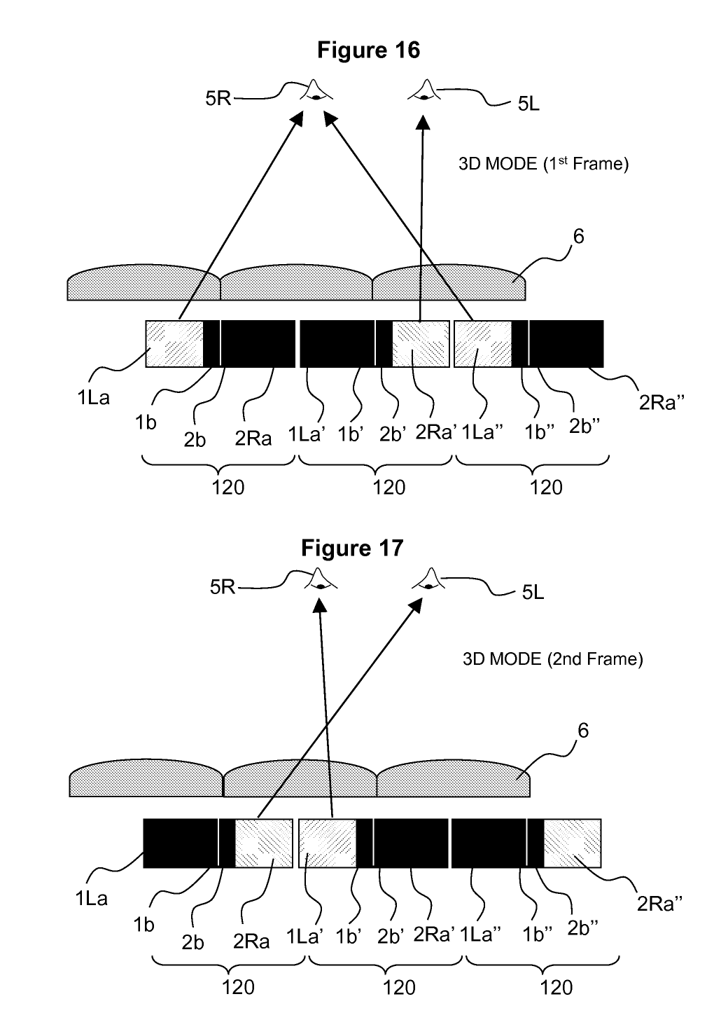

FIGS. 16 and 17 illustrate the operation of the embodiment of FIG. 15 in 3D mode. For the display of 3D images using a split sub-pixel scheme, the drive voltages may be applied such that 50% of each sub-pixel (i.e. 50% of the sub-regions) has substantially no luminance while the other 50% of the sub-regions have a luminance related to the respective eye data associated with an autostereoscopic 3D image (i.e. sub-regions that have left eye image data are directed towards the left eye and vice versa). Again briefly referring back to FIGS. 4a, 4b and 4c, this significant difference in luminance for sub-regions 1,2 of the same sub-pixel 120 is achieved via the application of a suitable voltage to V_{CS1} and V_{CS2} by the storage capacitor line driver 110,110′. According to FIG. 15, the resolution of the 3D image is 50%. The operation of FIG. 16 and FIG. 17 is essentially the same as FIG. 13 and FIG. 14 except that the optical element 6 and the array of split sub-pixels 120 have been off-set from each other by an amount substantially equal to half the pitch of the optical element 6.

FIG. 4c, FIG. 16 and FIG. 17 demonstrate that the 3D mode can be achieved in two distinct ways. Consequently, a time multiplexed scheme for display of 3D images can be realised using the details contained within FIG. 16 for a first display frame and using the details contained within FIG. 17 for a second display frame that is sequential the first. By alternating display frames between the scheme used in FIG. 16 and FIG. 17, a 3D image of 100% resolution can be realised.

With reference to FIG. 15, FIG. 16 and FIG. 17, a display with the capability to show autostereoscopic 3D images can be achieved with parallax optic 6 comprised entirely of a lens array that is adhered to the uppermost surface of a display device with glue. The parallax optic is centered symmetrically about the light modulation regions 1La and 2Ra of adjacent sub-pixels. The dimensions of the sub-pixel 4 are: width 1La=30 μm, width 1b=20 μm, width 2b=20 μm, width 2Ra=30 μm. Total sub-pixel width=100 μm. The lens has the following parameters: pixel to lens apex distance=450 μm, lens width=100 μm, lens radius 230 μm. The values and ratio of values described above are exemplary of a system capable of displaying autostereoscopic 3D images.

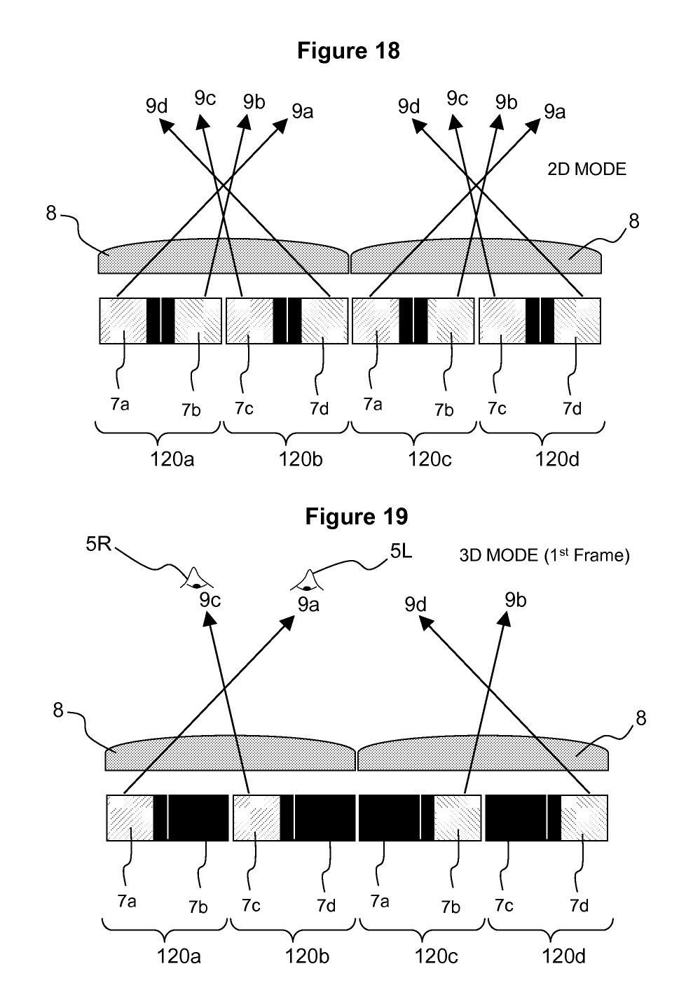

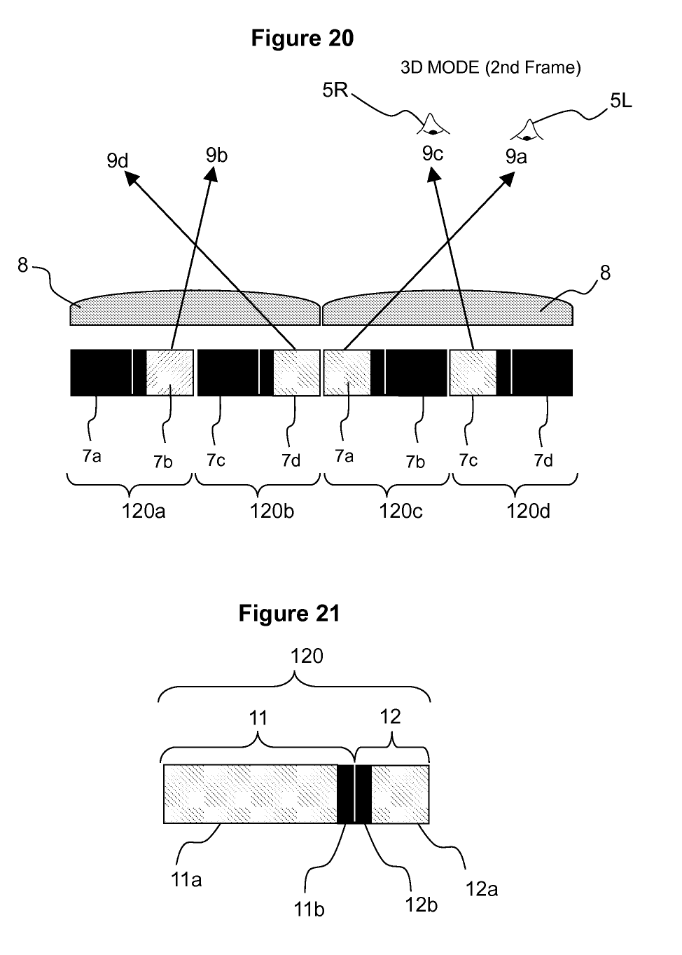

The use of standard pixels 3 in combination with an optical element, a camera module facing the user, face recognition image processing software and associated control mechanisms have previously been disclosed in U.S. Pat. No. 5,808,792 to realise a head tracked 3D system whereby the user can move laterally with respect to the display and always see a 3D image. The use of split sub-pixels 120 in combination with the technology disclosed in U.S. Pat. No. 5,808,792 (represented collectively in FIGS. 29 and 30 as camera and face recognition software 130) enables a head tracked 3D system with twice the resolution. The optical details of a four view 3D head tracked system, based upon the technology disclosed within U.S. Pat. No. 5,808,792 are described with reference to FIG. 18, FIG. 19 and FIG. 20. The use of split sub-pixels 120 in combination with the technology disclosed in U.S. Pat. No. 5,808,792 enables a head tracked 3D system with twice the resolution in the 2D mode.

With reference to FIG. 18, the optical element 6 is replaced with an optical element 8. The pitch of the optical element 8 is substantially twice that of a split sub-pixel 120 is used to create a first angularly dependent viewing window 9a, a second angularly dependent viewing window 9b, a third angularly dependent viewing window 9c and a fourth angularly dependent viewing window 9d. The viewing windows 9a, 9b, 9c and 9d are angularly distinct from each other. Light modulation sub-regins 7a, 7b, 7c and 7d, similar to sub-regions 1a,2a described above with respect to the previous embodiments, are presented across adjacent sub-pixels 120. The light modulation sub-regions 7a, 7b, 7c and 7d are viewed in the windows 9a, 9b, 9c and 9d respectively. At any given lateral position, the user will only see light from substantially two viewing windows. With reference to FIG. 18, in a first lateral location, the user will see light from one viewing window (for example, 9a) with one eye and will see light from a different viewing window (for example, 9c) with the other eye. With the user in a first lateral location, the user does not see light in viewing windows 9b and 9d. If the user moves to a second lateral location that is substantially different from the first lateral location, then the user will see light from viewing window 9b with one eye and light from viewing window 9d with the other eye, while viewing windows 9a and 9c are now obscured from view. The optical element 8 may be, for example, a lens array, a parallax barrier array or a combination of lens and parallax barrier elements.

With reference to FIG. 18, for the display of 2D images, the drive voltages may be applied to both sub-regions (for example, 7a and 7b) of a given split sub-pixel 120 by the control electronics 102 such that each sub-region 7a and 7b has substantially the same brightness. Alternatively, with reference to FIG. 18, for the display of 2D images the control electronics 102 may apply drive voltages to the sub-regions 7a and 7b in a manner as discussed previously in order to improve the off-axis colour reproduction of the 2D images. In either case, the display user sees 1 viewing window with one eye that is associated with a sub-region (for example, 7a) of a sub-pixel (for example, 120a) and a different viewing window with the other eye that is associated with a different sub-region (for example, 7c) of a different sub-pixel (for example, 120b). Consequently, the user perceives a 2D image resolution that is half of the native resolution of the display LC panel 104. It is worth noting that if the split sub-pixels 120 in FIG. 18 were replaced by standard sub-pixels 3, the user would perceive a 2D image resolution that is a quarter of the native resolution of the display panel since the required optical element 8 pitch would have to be substantially four times greater than the sub-pixel pitch 3. Consequently, the use of split sub-pixels 120 effectively doubles the 2D image resolution of a four view head tracked system relative to the use of standard sub-pixels 3. The particular arrangement of the split sub-pixels 120 in FIG. 18 is based on the arrangement shown in FIG. 8. However, it will be appreciated that other split-pixel arrangements such as the split sub-pixel arrangements shown in FIGS. 9 and 10 are all interchangeable for use in the embodiment of FIGS. 18-20.

With reference to FIGS. 19 and 20, for the display of 3D images, the drive voltages provided by the control electronics may be applied such that 50% of each sub-pixel 120 (i.e. 50% of the sub-regions) has substantially no luminance while the other 50% of the sub-pixel 120 sub-regions have a luminance related to the respective eye data associated with an autostereoscopic 3D image. Again, this significant difference in luminance for the two sub-regions of the same sub-pixel 120 is achieved via the application of a suitable voltage to V_{CS1} and V_{CS2} by the storage capacitor line driver 110,110′.

With reference to FIG. 19, sub-region 7a of split sub-pixel 120a has a luminance related to the left eye data of an autostereoscopic 3D image while sub-region 7b of split sub-pixel 120a has substantially no luminance (i.e. is switched black). With reference to FIG. 19, sub-region 7c of split sub-pixel 120b has a luminance related the right eye data of an autostereoscopic 3D image while sub-region 7d of split sub-pixel 120b has substantially no luminance (i.e. is switched black). With reference to FIG. 19, sub-region 7a of split sub-pixel 120c has substantially no luminance (i.e. is switched black) and sub-region 7c of split sub-pixel 120d also has substantially no luminance (i.e. is switched black). The luminance of sub-region 7b of split sub-pixel 120c and the luminance of sub-region 7d of split sub-pixel 120d is related to either the left or right eye data associated with an autostereoscopic 3D image. To determine whether sub-region 7b of split sub-pixel 120c displays left eye data or right eye data, the use of a camera and face recognition software 130 is employed as described in U.S. Pat. No. 5,808,792 in order to ascertain the direction of lateral motion (left or right) of the user. According to FIG. 19 and FIG. 20, the resolution of the 3D image is 25%.

With reference to FIG. 20, sub-region 7a of split sub-pixel 120c has a luminance related the left eye data of an autostereoscopic 3D image while sub-region 7c of split sub-pixel 120d has luminance related the right eye data of an autostereoscopic 3D image. The luminance of sub-region 7b of split sub-pixel 120a and the luminance of sub-region 7d of split sub-pixel 120b is related to either the left or right eye data associated with an autostereoscopic 3D image. To determine whether sub-region 7c of split sub-pixel 120b displays left eye data or right eye data, the use of a camera and face recognition software 130 is employed as described in U.S. Pat. No. 5,808,792 in order to ascertain the direction of lateral motion (left or right) of the user.

FIG. 4c, FIG. 19 and FIG. 20 demonstrate that the 3D mode can be achieved in two distinct ways. Consequently, a time multiplexed scheme for display of 3D images can be realised using the details contained within FIG. 19 for a first display frame and using the details contained within FIG. 20 for a second display frame that is sequential the first. By alternating display frames between the scheme used in FIG. 16 and FIG. 17, a 3D image of 50% resolution can be realised for a 4-view head tracked 3D system.

With reference to the embodiment of FIGS. 18, 19 and 20, a display 100,100′ with the capability to show autostereoscopic 3D images can be achieved with parallax optic 8 comprised entirely of a lens array that is adhered to the uppermost surface of a LC panel 104 with glue. The parallax optic spans two sub-pixels 120 and is centered symmetrically about two sub-pixels 120. The dimensions of the sub-pixel 120 are: width 7a=7b=30 μm. Total sub-pixel width=100 μm. The lens array 8 has the following parameters: pixel to lens apex distance=800 μm, lens width=200 μm, lens radius 300 μm. The values and ratio of values described above are exemplary of a system capable of displaying autostereoscopic 3D images.

The embodiments of FIGS. 12-14 and FIGS. 15-17 illustrate that the optical element 6 can be shifted laterally relative to the LC panel 104 by an amount substantially equal to half the pitch of the sub-pixels 120 and still achieve a switchable 2D/3D display system. Likewise, the optical element 8 shown in the embodiment of FIGS. 18-20 may also be shifted laterally relative to the display by multiples of half the sub-pixel pitch and still achieve a switchable 2D/3D display system. The 2D/3D display system according to the embodiment illustrated in FIGS. 18-20 may be made up of any one or combination of sub-pixel arrangements as exemplified in FIGS. 8-10 as will be appreciated.

With reference to FIG. 21, an asymmetric split sub-pixel 120 is comprised of two sub-regions 11 and 12. The regions 11 and 12 are further divided in two sub-regions for light modulation 11a and 12a, and, two sub-regions of electronics 11b and 12b that control the light modulation sub-regions 11a and 12a respectively. The light modulation sub-regions 11a and 12a may be further divided into partial sub-regions that modulate the amount of light transmitted through the LC panel 104 and partial sub-regions that modulate the amount of reflected light from the LC panel 104. In some cases, the partial sub-regions that modulate light reflected from the LC panel 104 are situated on top of the electronics region 11b, 12b.

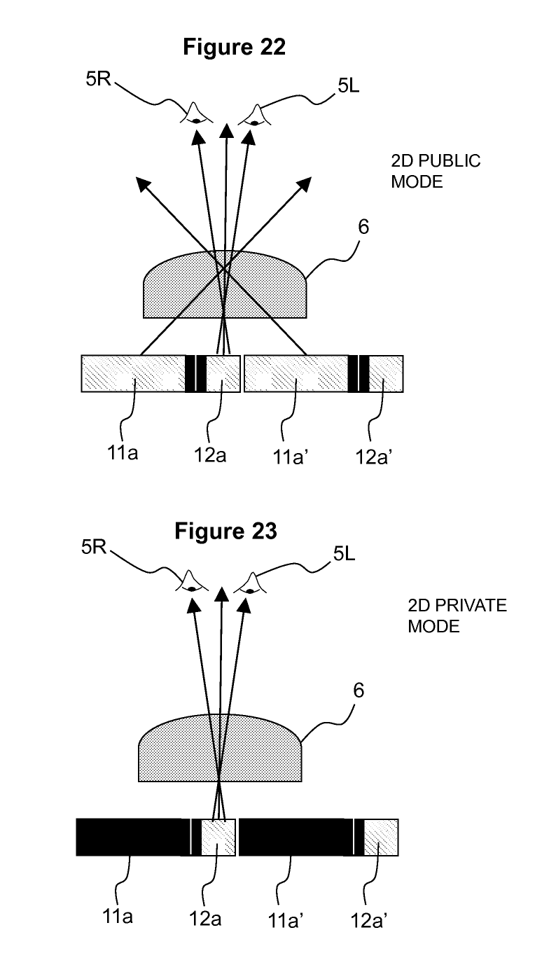

With reference to FIG. 22, an optical element 6 with a pitch that is substantially the same as the asymmetric split sub-pixel 120 is used to create a first off-axis angularly dependent viewing window for light modulation regions 11a, and a second off-axis angularly dependent viewing window that is symmetric to 11a with respect the display normal for light modulation region 11a′. The off-axis viewing window can only be seen for angles >10° to the display normal. A third on-axis angularly dependent viewing window for light modulation region 12a is also shown. The on-axis viewing window can only be seen for angles <50° of the display normal.

With reference to FIG. 22, for the display of public wide view 2D images, the drive voltages may be applied by the control electronics 102 to both sub-regions of an asymmetric split sub-pixel 120 (for example, 11a and 12a) such that each sub-region (for example, 11a and 12a) has substantially the same brightness density. The same image is therefore seen for all on-axis and off-axis angles.

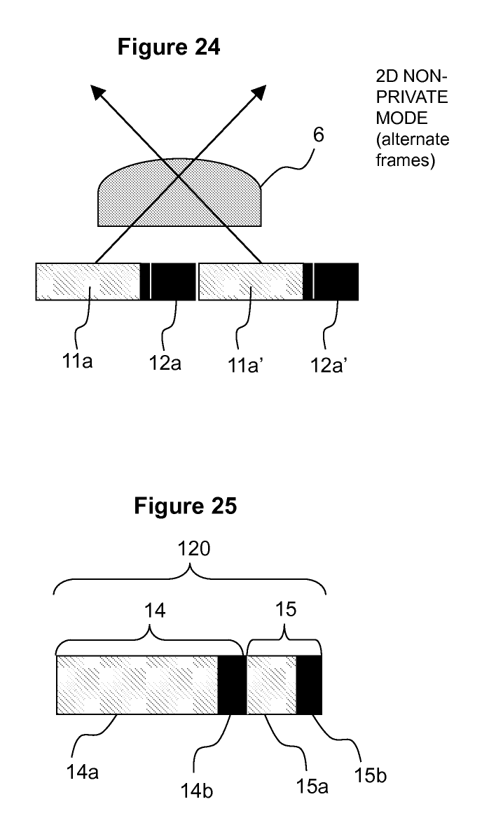

For the display of private narrow view 2D images using a split sub-pixel scheme, the drive voltages may be applied by the control electronics 102 such that 50% of each sub-pixel 120 (i.e. 50% of the sub-regions) has substantially no luminance while the other 50% of the sub-pixel 120 sub-regions have a luminance related to the image data. With reference to FIG. 23, for the display of private narrow view on-axis 2D images, the drive voltages on sub-regions 12a, 12a′ etc. (V_{cs2}) are applied by the storage capacitance driver 110,110′ such that image data associated with a private image is seen on-axis while the drive voltage applied to sub-regions 11a, 11a′ etc. (V_{cs1}) are applied by the storage capacitance driver 110,110′ such that sub-regions 11a, 11a′ etc. have substantially no luminance. With reference to FIG. 24, for the display of non-private off-axis 2D images, the drive voltages on sub-regions 12a, 12a′ etc. (V_{cs2}) are applied such that sub-regions 12a, 12a′ etc. have substantially no luminance while the drive voltages on sub-regions 11a, 11a′ etc. (V_{cs1}) are applied such that image data associated with non-private image is seen off-axis.

A first implementation of a privacy mode requires time multiplexing of 2 different frames which are shown sequentially. If private narrow view on-axis 2D images, as illustrated in FIG. 23, are shown in time frame 1 and non-private off-axis 2D images, as illustrated FIG. 24, are shown in time frame 2 (sequential to time frame 1) then a privacy display is realised whereby the user sees private 2D images on-axis while an off-axis 3^{rd} party sees non-private 2D images.

A second implementation of a privacy mode does not require time multiplexing. If the private, narrow view of on-axis 2D images, as illustrated in FIG. 23, are shown in all time frames, then a privacy display is realised whereby the user sees private 2D images on-axis while an off-axis 3^{rd} party sees a display that is substantially devoid of luminance.

The first implementation of the privacy mode (time multiplexing) has the advantage that the privacy strength is greater than the second implementation of the privacy mode (non-time multiplexing) since the non-private off-axis image further disguises the on-axis image. However, the second implementation of the privacy mode (non-time multiplexing) has the advantage that the private on-axis 2D image is twice as bright as the first implementation of the privacy mode (time multiplexing) since the on-axis image in the second implementation is displayed for twice as many time frames.

With reference to the embodiment of FIGS. 21-24, a display with the capability of a public, wide view image mode and a private, narrow view image mode using parallax optic 6 comprised entirely of a lens array that is adhered to the uppermost surface of the LC panel 104 with glue. The parallax optic 6 is centered symmetrically about the light modulation region 12a. The dimensions of the sub-pixel are: 11a=45 μm, 11b=25 μm, 12b=15 μm, 12b=15 μm. Total sub-pixel width=100 μm. The lens has the following parameters: pixel to lens apex distance=75 μm, lens width=100 μm, lens radius 60 μm. The values and ratio of values described above are exemplary of a system capable of a public, wide view image mode and a private, narrow view image mode.

With reference to FIGS. 25-27, a display system utilising split sub-pixels can be realised that has the following image display modes: a public wide view 2D image mode, a private narrow view 2D image mode, an autostereoscopic 3D mode, and a private autostereoscopic 3D mode (private viewing of 3D image). In the public wide view 2D image mode, the image can be discerned over a large range of incident angles. In the private narrow view 2D image mode, a private image can be discerned by the user for a limited range of on-axis angles but the private narrow view 2D image is not discernable by a 3^{rd} party viewing the display at angles that are substantially off-axis to the display.

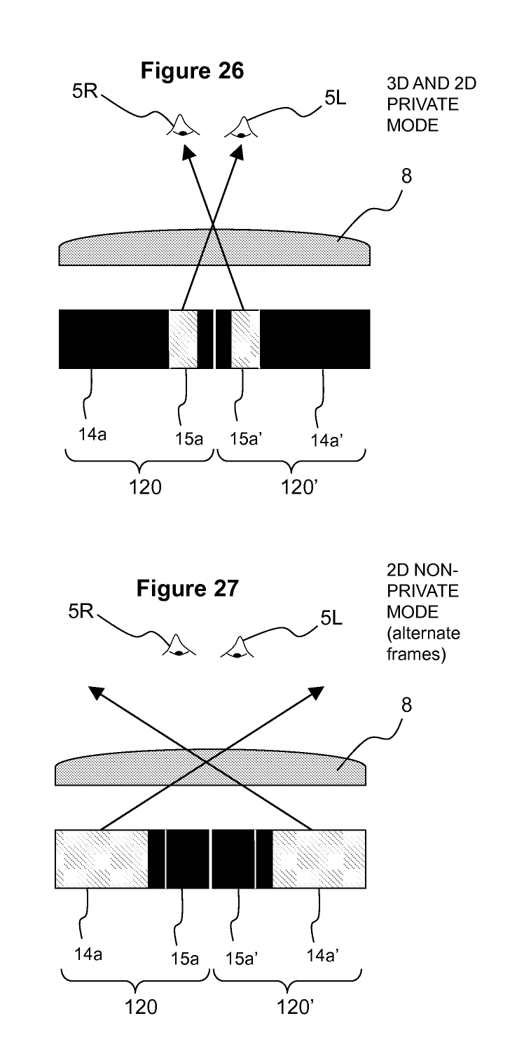

With reference to FIG. 25 and FIG. 26, a split sub-pixel 120 is comprised of two sub-regions 14a and 15a for modulating luminance and the respective control electronics 14b and 15b for sub-regions 14a and 15a. For the viewing of public wide view 2D images, the image is simply addressed to the panel in a standard fashion as shown previously in FIGS. 12, 15, 18 and 22.

With reference to FIG. 26, for the viewing of private narrow view 2D images, sub-regions 15a, 15a′ etc. have a luminance related the private 2D image.

A first implementation of a privacy mode requires time multiplexing of 2 different frames that are shown sequentially. If private narrow view on-axis 2D images, as described by FIG. 26, are shown in time frame 1 and non-private off-axis 2D images, as described by FIG. 27, are shown in time frame 2 (sequential to time frame 1) then a privacy display is realised whereby the user sees private 2D images on-axis while an off-axis 3^{rd} party sees non-private 2D images.

A second implementation of a privacy mode does not require time multiplexing. If private narrow view on-axis 2D images, as described by FIG. 26, are shown in all time frames and then a privacy display is realised whereby the user sees private 2D images on-axis while an off-axis 3^{rd} party sees a display that is substantially devoid of luminance.

The first implementation of the privacy mode (time multiplexing) has the advantage that the privacy strength is greater than the second implementation of the privacy mode (non-time multiplexing) since the non-private off-axis image further disguises the on-axis image. However, the second implementation of the privacy mode (non-time multiplexing) has the advantage that the private on-axis 2D image is twice as bright as the first implementation of the privacy mode (time multiplexing) since the on-axis image in the second implementation is displayed for twice as many time frames.

With reference to FIG. 26 for the viewing of 3D images, sub-region 15a of split sub-pixel 120 has a luminance related the left eye data of an autostereoscopic 3D image while sub-region 14a of split sub-pixel 13 has substantially no luminance (i.e. is switched black).

With reference to FIG. 26, sub-region 15a′ of split sub-pixel 120′ (rotated 180° relative to adjacent sub-pixel 120) has a luminance related the right eye data of an autostereoscopic 3D image while sub-region 14a′ of split sub-pixel 120′ has substantially no luminance (i.e. is switched black).

A first implementation of the 3D mode requires time multiplexing of 2 different frames which are shown sequentially. If private narrow view on-axis 3D images, as described by FIG. 26, are shown in time frame 1 and non-private off-axis 2D images, as described by FIG. 27, are shown in time frame 2 (sequential to time frame 1) then a privacy 3D display is realised whereby the user sees private 3D images on-axis while an off-axis 3^{rd} party sees non-private 2D images.

A second implementation of the 3D mode does not require time multiplexing. If private narrow view on-axis 3D images, as described by FIG. 26, are shown in all time frames and then a privacy 3D display is realised whereby the user sees private 3D images on-axis while an off-axis 3^{rd} party sees a display that is substantially devoid of luminance.

The first implementation of the 3D mode (time multiplexing) has the advantage that the privacy strength is greater than the second implementation of the 3D mode (non-time multiplexing) since the non-private off-axis image further disguises the on-axis image. However, the second implementation of the 3D mode (non-time multiplexing) has the advantage that the on-axis 3D image is twice as bright as the first implementation of the 3D mode (time multiplexing) since the on-axis image in the second implementation is displayed for twice as many time frames.

With reference to the embodiment of FIGS. 25-27, a display system utilising split sub-pixels can be realised that has the following image display modes: a public wide view 2D image mode, a private narrow view 2D image mode, an autostereoscopic 3D mode, a private autostereoscopic 3D mode (private viewing of 3D image) using parallax optic 8 comprised entirely of a lens array that is adhered to the uppermost surface of a display device with glue. The parallax optic 8 is centered symmetrically about two adjacent sub-pixels. The dimensions of the sub-pixel are: 11a=30 μm, 11b=20 μm, 12a=15 μm, 12b=35 μm. Total sub-pixel width=100 μm. The lens has the following parameters: pixel to lens apex distance=100 μm, lens width=200 μm, lens radius 120 μm. The values and ratio of values described above are exemplary of a system capable of a public wide view 2D image mode, a private narrow view 2D image mode, an autostereoscopic 3D mode, a private autostereoscopic 3D mode (private viewing of 3D image).

Although the invention has been shown and described with respect to a certain embodiment or embodiments, equivalent alterations and modifications may occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein exemplary embodiment or embodiments of the invention. In addition, while a particular feature of the invention may have been described above with respect to only one or more of several embodiments, such feature may be combined with one or more other features of the other embodiments, as may be desired and advantageous for any given or particular application.

### INDUSTRIAL APPLICABILITY

A display device which is capable of at least two different image display functions. The two different image display functions may include, for example, a conventional display, a privacy display, an autostereoscopic 3D display. Such a display may be used as a directional display in, for example, a mobile phone, portable media players, games devices, a laptop personal computer, a television, a desktop monitor, etc.

1. A display, comprising:
a plurality of sub-pixels each split into a plurality of sub-regions, wherein each sub-pixel includes a single gate line and a single signal line, and each sub-region within a given sub-pixel includes a corresponding storage capacitor line;
an optical element cooperatively combined with the plurality of sub-pixels to create distinct angularly dependent brightness functions in association with corresponding sub-regions within the sub-pixels; and
control electronics configured to provide image data levels in the form of signal data voltages to each sub-region included within each sub-pixel via the gate line and signal line included within the sub-pixel; and to independently modify the signal data voltages provided to each sub-region within the sub-pixels via the corresponding storage capacitor lines whereby the display operates in accordance with at least two different image functions.

2. The display according to claim 1, wherein the at least two different image functions are selected from among a group consisting of a public wide view 2D mode, a private narrow view 2D mode, a public wide view 3D mode, a private narrow view 3D mode, and a dual view mode.

3. The display according to claim 1, wherein the control electronics modify the signal data voltage provided to each sub-region of a given sub-pixel by a same amount via the corresponding storage capacitor lines.

4. The display accordingly to claim 1, wherein the control electronics modify the signal data voltage provided to each sub-region of a given sub-pixel by a different amount and in order that each sub-region of the sub-pixel has an appreciable brightness for non-zero image data levels.

5. The display according to claim 1, wherein the control electronics modify the signal data voltage provided to at least one sub-region of a given sub-pixel by an amount such that the at least one sub-region has substantially no brightness for all image data levels.

6. The display according to claim 1, wherein the control electronics are configured to drive the plurality of sub-pixels in a time-multiplexed manner such that during a first time frame a first set of sub-regions of a given sub-pixel has substantially no brightness regardless of the image data level provided to the sub-pixel, and, during the first time frame a second set of sub-regions of the given sub-pixel has a brightness substantially related to the image data level provided to the sub-pixel; and, during a second time frame sequential to the first time frame the first set of sub-regions of the sub-pixel has a brightness substantially related to the image data level provided to the sub-pixel, and, during the second time frame sequential to the first time frame the second set of sub-regions of the sub-pixel has substantially no brightness regardless of the image data level provided to the sub-pixel.

7. The display according to claim 1, wherein the sub-pixels each comprise a first sub-region and a second sub-region; the optical element comprises a parallax element that has substantially the same pitch as the sub-pixels, the parallax element cooperating with the first sub-region of a given sub-pixel to produce a first angularly dependent brightness function and cooperating with the second sub-region of the sub-pixel to produce a second angularly dependent brightness function different from the first angularly dependent brightness function; and the control electronics are configured to independently modify the signal data voltages provided to the first and second sub-regions using the corresponding storage capacitor lines to produce 2D and 3D viewing modes.

8. The display according to claim 1, wherein the sub-pixels each comprise a first sub-region and a second sub-region; the optical element comprises a parallax element that has substantially the same pitch as the sub-pixels, the parallax element cooperating with the first sub-region of a given sub-pixel to produce a first on-axis angularly dependent brightness function and cooperating with the second sub-region of the sub-pixel to produce a second off-axis angularly dependent brightness function different from the first angularly dependent brightness function;
and the control electronics are configured to independently modify the signal data voltages provided to the first and second sub-regions using the corresponding storage capacitor lines to produce public wide view 2D and private narrow view 2D viewing modes.

9. The display according to claim 1, wherein the sub-pixels each comprise a first sub-region and a second sub-region; the optical element comprises a parallax element having substantially twice the pitch of the sub-pixels and, with respect to adjacent pairs of first and second sub-pixels among the plurality of sub-pixels, the parallax optic cooperating with the first sub-region of the first sub-pixel to produce a first angularly dependent brightness function, cooperating with the second sub-region of the first sub-pixel to produce a second angularly dependent brightness function, cooperating with the first sub-region of the second sub-pixel to produce a third angularly dependent brightness function and cooperating with the second sub-region of the second sub-pixel to produce a fourth angularly dependent brightness function,
further comprising a camera configured to track head movements and operatively coupled to the control electronics, and wherein the control electronics are configured to independently modify the signal data voltages provided to the first and second sub-regions using the corresponding storage capacitor lines to produce 2D and head tracked 3D viewing modes.

10. The display according to claim 1, wherein the sub-pixels each comprise a first sub-region and a second sub-region; the optical element comprises a parallax element having substantially twice the pitch of sub-pixels, the parallax optic cooperating with the first sub-region of a first and a second sub-pixel to produce angularly dependent brightness functions for use with viewing 2D images on-axis and 3D images, and cooperating with the second sub-region of the first sub-pixel and second sub-pixel to produce angularly dependent brightness functions for use with viewing of 2D images off-axis; and wherein the control electronics are configured to independently modify the signal data voltages provided to the first and second sub-regions using the corresponding storage capacitor lines to produce 2D, private narrow 2D and 3D viewing modes

11. The display according to claim 1, wherein the sub-pixels each comprise a first sub-region and a second sub-region; the optical element comprises a parallax element having substantially the same pitch as the sub-pixels, the parallax optic cooperating with the first sub-region of a given sub-pixel to produce a first angularly dependent brightness function, and cooperating with the second sub-region of the sub-pixel to produce a second angularly dependent brightness function that is different from the first angularly dependent brightness function, and wherein the control electronics are configured to independently modify the signal data voltages provided to the first and second sub-regions using the corresponding storage capacitor lines to present dual views in time sequential manner.

12. The display accordingly to claim 1, wherein the optical element is a parallax barrier that is comprised of transmissive and non-transmissive regions, a lens array, or a combination thereof.
